(19) United States
(12) Patent Application Publication
(10) Pub. No.: US 2026/0075573 A1
(43) Pub. Date: Mar. 12, 2026

(54) TERMINAL APPLICABLE TO SL POSITIONING SCENARIO

(71) Applicant: GUANGDONG OPPO MOBILE TELECOMMUNICATIONS CORP., LTD., Dongguan (CN)

(72) Inventors: Xinlei YU, Dongguan (CN); Yang LIU, Dongguan (CN)

(21) Appl. No.: 19/388,581

(22) Filed: Nov. 13, 2025

Related U.S. Application Data
(63) Continuation of application No. PCT/CN2023/109194, filed on Jul. 25, 2023.

(51) Int. Cl. H04W 64/00; H04B 17/318; H04W 72/25

(52) U.S. Cl. CPC H04W 64/00; H04B 17/328; H04W 72/25

(57) ABSTRACT

Provided is a terminal applicable to an SL positioning service scenario, wherein the terminal is applied in a target UE, and the terminal includes: a processor, a transceiver connected to the processor, and a memory configured to store one or more executable instructions of the processor; wherein the processor is configured to load the one or more executable instructions to cause the terminal to: receive a ranging/SL positioning service request; and determine an SL positioning server UE, wherein the SL positioning server UE is a UE used to implement an SL positioning service function.

### CROSS-REFERENCE TO RELATED APPLICATION

This application is a continuation of International Application No. PCT/CN2023/109194, filed Jul. 25, 2023, the entire disclosure of which is incorporated herein by reference.

### TECHNICAL FIELD

The present disclosure relates to the field of sidelink positioning, and in particular, relates to a terminal applicable to a sidelink (SL) positioning service scenario.

### RELATED ART

SL positioning refers to positioning between the user equipments (UEs).

In an in-coverage (IC) scenario for SL positioning, an anchor UE and a target UE are both in a state of connection with the 5G (5th generation mobile communication technology) system, and SL positioning assistance information between the target UE and the anchor UE is uploaded to a location management function (LMF) network element. The LMF performs unified aggregation and calculates the result, thus achieving positioning.

In an out-of-coverage (OOC) scenario for SL positioning, the anchor UE and the target UE are both in a state of no connection with the 5G system. In such a scenario, no LMF is present, and how to achieve sidelink positioning is still under discussion.

### SUMMARY

Embodiments of the present disclosure provide a terminal applicable to a sidelink (SL) positioning service scenario. The technical solutions are as follows.

According to some embodiments of the present disclosure, a terminal applicable to an SL positioning service scenario is provided. The terminal includes: a processor; a transceiver, connected to the processor; and a memory, configured to store one or more executable instructions of the processor; wherein the processor is configured to load the one or more executable instructions to cause the terminal to: receive a ranging/SL positioning service request; and determine an SL positioning server UE, wherein the SL positioning server UE is a UE used to implement an SL positioning service function.

According to some embodiments of the present disclosure, a terminal applicable to an SL positioning service scenario is provided. The terminal includes: a processor; a transceiver, connected to the processor; and a memory, configured to store one or more executable instructions of the processor; wherein the processor is configured to load the one or more executable instructions to cause the terminal to: receive a request message from a target UE; and transmit a response message to the target UE, the response message carrying information for the target UE to determine an SL positioning server UE; wherein the second UE is one of candidate UEs, the candidate UEs being UEs that are candidates of the SL positioning server UE; and the request message is used to request the second UE to serve as the SL positioning server UE.

According to some embodiments of the present disclosure, a terminal applicable to an SL positioning service scenario is provided. The terminal includes: a processor; a transceiver, connected to the processor; and a memory, configured to store one or more executable instructions of the processor; wherein the processor is configured to load the one or more executable instructions to cause the terminal to: receive a request message from a target UE; and transmit a response message to the target UE; wherein the request message is used to request a receiver UE to serve as the SL positioning server UE, and the response message is used to indicate whether the receiver UE agrees to serve as the SL positioning server UE.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a communication system according to some embodiments of the present disclosure;

FIG. 2 is a schematic diagram of sidelink communication according to some embodiments of the present disclosure;

FIG. 3 is a schematic diagram of sidelink communication according to some embodiments of the present disclosure;

FIG. 4 is a schematic diagram of sidelink communication according to some embodiments of the present disclosure;

FIG. 5 is a schematic diagram of an SL discovery process according to some embodiments of the present disclosure;

FIG. 6 is a schematic diagram of an SL discovery process according to some embodiments of the present disclosure;

FIG. 7 is a schematic diagram of an SL positioning procedure according to some embodiments of the present disclosure;

FIG. 8 is a schematic diagram of an SL positioning procedure according to some embodiments of the present disclosure;

FIG. 9 is a schematic diagram of an SL positioning procedure according to some embodiments of the present disclosure;

FIG. 10 is a schematic diagram of a communication method applicable to an SL positioning service scenario according to some embodiments of the present disclosure;

FIG. 11 is a schematic diagram of a communication method applicable to an SL positioning service scenario according to some embodiments of the present disclosure;

FIG. 12 is a schematic diagram of a communication method applicable to an SL positioning service scenario according to some embodiments of the present disclosure;

FIG. 13 is a schematic diagram of a communication method applicable to an SL positioning service scenario according to some embodiments of the present disclosure;

FIG. 14 is a schematic diagram of a communication method applicable to an SL positioning service scenario according to some embodiments of the present disclosure;

FIG. 15 is a structural block diagram of a communication apparatus applicable to an SL positioning service scenario according to some embodiments of the present disclosure;

FIG. 16 is a structural block diagram of a communication apparatus applicable to an SL positioning service scenario according to some embodiments of the present disclosure; and

FIG. 17 is a structural block diagram of a communication apparatus applicable to an SL positioning service scenario according to some embodiments of the present disclosure; and

FIG. 18 is a structural block diagram of a communication apparatus applicable to an SL positioning service scenario according to some embodiments of the present disclosure; and

FIG. 19 is a schematic structural diagram of a communication device according to some embodiments of the present disclosure.

### DETAILED DESCRIPTION

For clearer descriptions of the objectives, technical solutions, and advantages of the present disclosure clearer, embodiments of the present disclosure are further described in detail hereinafter with reference to the accompanying drawings. The embodiments are described in detail herein, and examples are illustrated in the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to limit the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” and the like may be used herein to describe various pieces of information, and such information should not be limited to these terms. These terms are only used to distinguish one type of information from another. For example, first information may also be referred to as second information, and similarly, second information may be also referred to as first information, without departing from the scope of the present disclosure. The word “if,” as used herein, may be interpreted as “in a case where,” “in a case when,” or “in response to determining that,” depending on the context.

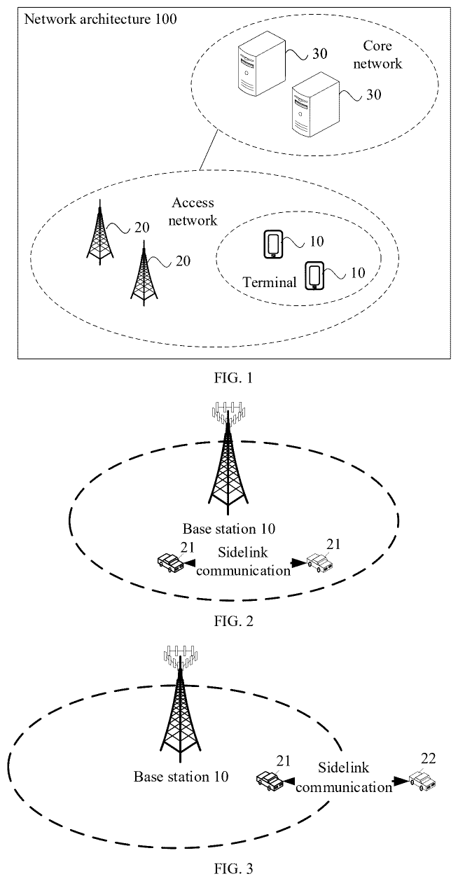

FIG. 1 is a schematic diagram of a network architecture according to some embodiments of the present disclosure. The network architecture 100 may involve a terminal 10, an access network device 20, and a core network device 30.

The terminal 10 is a user equipment (UE), an access terminal, a subscriber unit, a subscriber station, a mobile station, a mobile console, a remote station, a remote terminal, a mobile device, a wireless communication device, a user agent, a user device, or the like. In some embodiments, the terminal 10 is a cellular phone, a cordless phone, a Session Initiation Protocol (SIP) phone, a wireless local loop (WLL) station, a personal digital assistant (PDA), a handheld device with a wireless communication function, a computing device or other processing devices connected to a radio modem, an in-vehicle device, a wearable device, a terminal in a 5th generation system (5GS) or a terminal in a future public land mobile network (PLMN), which is not limited in the embodiments of the present disclosure. The devices described above are collectively referred to as terminals for convenient description. Generally, a plurality of terminal devices 10 are provided. One or more of the terminal devices 10 are disposed in a cell managed by each of the access network devices 20.

The access network device 20 is a device deployed in the access network and configured to provide a wireless communication function to the terminal 10. The access network device 20 includes various types of macro base stations, micro base stations, relay stations, access points, and the like. In systems using different radio access technologies, the devices having the functions of the access network device may have different names, for example, the gNodeBs, or gNBs in 5G new radio (NR) systems. With the evolution of communications technologies, the name “access network device” may vary. For convenient description, the above devices providing the wireless communication function for the terminal 10 are collectively referred to as the access network device in the embodiments of the present disclosure. In some embodiments, the terminal 10 communicates with the core network device 30 via the access network device 20. Illustratively, in a long-term evolution (LTE) system, the access network device 20 is an evolved universal terrestrial radio access network (EUTRAN) or one or more eNodeBs in the EUTRAN; and in a 5G NR system, the access network device 20 is a radio access network (RAN) or one or more gNBs in the RAN. In the embodiments of the present disclosure, the network device is the access network device 20, for example, a station, unless otherwise specified.

The core network device 30 is a device deployed in the core network, mainly functions for user connection, user management and service bearing, and acts as a bearer network for providing an interface to an external network. For example, the core network device in the 5G NR system includes an access and mobility management function (AMF) network element, an authentication server function (AUSF) network element, a user plane function (UPF) network element, a session management function (SMF) network element, a location management function (LMF) network element, a policy control function (PCF) network element, a unified data management (UDM) network element, and the like.

In some embodiments, the access network device 20 and the core network device 30 communicate with each other using the air interface technology, such as the NG interface in the 5G NR system. The access network device 20 and the terminal 10 communicate with each other using the air interface technology, such as a Uu interface.

The access network device is an access device that allows the terminal device to connect to a network architecture thereof in a wireless mode, and mainly functions for wireless resource management, quality of service (QoS) management, data compression, and encryption on the air interface side. For example, the access network device is a NodeB, an evolved eNodeB, a station in a 5G mobile communication system or an NR communication system, a station in a future mobile communication system, or the like.

The core network device includes a network slice selection function (NSSF), an AUSF, a UDM, an AMF, an SMF, a PCF, and a UPF.

The UE is connected to (R)AN at an access stratum over a Uu interface to exchange an access stratum message and transmit wireless data. The UE is connected to the AMF at a non-access stratum (NAS) over an N1 interface to exchange a NAS message. The AMF is a mobility management function in the core network, the SMF is a session management function in the core network. In addition to mobility management for the UE, the AMF also functions to forward a session management message between the UE and the SMF. The PCF is a policy management function in the core network, and functions to formulate policies for UE mobility management, session management, and billing. The PCF achieves data transmission with an external application function (AF) over an N5 interface. The UPF is a user-plane function in the core network, and achieves data transmission with an external data network (DN) over an N6 interface and with an AN over an N3 interface.

The “5G NR system” in the embodiments of the present disclosure is also referred to as a 5G system or an NR system, and those skilled in the art understand the meaning. The technical solutions according to the embodiments of the present disclosure are applicable to the LTE system, the 5G NR system, evolved systems of the 5G NR system, a narrow band Internet of things (NB-IoT), or other communication systems, which is not limited in the present disclosure.

First, the relevant content involved in the present disclosure is introduced.

SL positioning client UE: A third-party UE other than an anchor UE and a target UE, representing an application program residing thereon to initiate a ranging/SL positioning service request.

In some embodiments, the SL positioning client UE is not required to support the ranging/SL positioning capability, but must establish communication between the SL positioning client UE and the anchor UE/target UE over PC5 or 5GC to transmit the ranging/SL positioning service request and result.

Target UE: A UE whose distance, direction, and/or position is measured in a service based on ranging/SL positioning, with the support of one or more anchor UEs on the SL.

Anchor UE: A UE that supports the positioning of a target UE. For example, the support is provided by using SL to transmit and/or receive a reference signal for SL positioning, provide positioning-related information, or the like.

In some embodiments, the anchor UE is a UE configured to transmit and/or receive the reference signal for SL positioning by using SL.

In some embodiments, the anchor UE is a UE that provides positioning-related information to a target UE or a server UE.

In some embodiments, the anchor UE is also referred to as the SL reference UE.

In some embodiments, an anchor UE with a known position or capable of acquiring its own position through Uu positioning is also referred to as an anchor UE capable of acquiring its own position (located UE).

SL positioning server UE: AUE with assistance data distribution and/or position calculation functions, determined based on a ranging/SL positioning service request.

In some embodiments, the SL positioning server UE interacts with a target UE, an anchor UE, or another UE other than the anchor UE and the target UE over PC5 when necessary to determine a ranging/SL positioning method, distribute assistance data, and calculate the position of the target UE.

In some embodiments, the SL positioning server UE is at least one of:
a target UE;
an anchor UE; or
another UE other than the anchor UE and the target UE.

### SL Transmission Technology

Unlike conventional cellular systems in which communication data is received or transmitted through an access network device, SL transmission refers to direct communication data transmission between terminals via the sidelink.

Regarding SL transmission, the 3rd generation partnership project (3GPP) defines two transmission models: Model A and Model B.

Model A: The transmission resources for SL UE are allocated by the access network device. The SL UE transmits communication data over the sidelink based on the transmission resources allocated by the access network device, wherein the access network device may allocate transmission resources of a single transmission or transmission resources of a semi-static transmission for the SL UE.

Model B: The SL UE selects one or more transmission resources from a resource pool to transmit communication data. The SL UE may select transmission resources in the resource pool by means of listening or by randomly selecting transmission resources from the resource pool. In the case of performing SL transmission on an unlicensed spectrum, the access network device may pre-configure a plurality of resource pools for the UE (such as SL PRS resource pool and SL-U communication resource pool). In the case of executing a specific service, the UE may select resources from a corresponding resource pool to execute the listen before talk (LBT) process. In a case where LBT is successful, the UE may occupy these resources to perform sidelink transmission on the unlicensed spectrum. While transmitting sidelink data on these resources, the UE will also transmit SCI, wherein the SCI indicates the resources currently occupied by the UE for sidelink transmission. Furthermore, SCI may also be used to indicate resources reserved by the UE. For example, in a case where the UE occupies a portion of resources in the SL PRS resource pool by LBT to transmit SL PRS, the UE transmits the SL PRS and SCI-P on the portion of resources. The SCI-P indicates resources occupied by the current SL PRS, as well as resources reserved for subsequent SL PRS.

In SL transmission, based on the network coverage conditions of the terminals in communication, sidelink communication may be categorized into in-coverage sidelink communication, partial-coverage sidelink communication, and out-of-coverage sidelink communication, as illustrated in FIGS. 2, 3, and 4, respectively.

FIG. 2: In the case of in-coverage sidelink communication, all terminals 21 performing sidelink communication are within the coverage area of the same base station 10. Thus, all the terminals 21 can receive configuration signaling from the base station 10 and perform sidelink communication based on the same sidelink configuration.

FIG. 3: In the case of partial-coverage sidelink communication, some of the terminals 21 performing sidelink communication are within the coverage area of the base station, and these terminals 21 can receive configuration signaling from the base station 10 and perform sidelink communication based on the configuration of the base station 10. Terminals 22 located outside the network coverage area cannot receive configuration signaling from the base station 10. In this case, terminals 22 outside the network coverage area determine the sidelink configuration based on pre-configuration information and the information carried in the physical sidelink broadcast channel (PSBCH) transmitted by terminals 21 within the network coverage area, and perform sidelink communication.

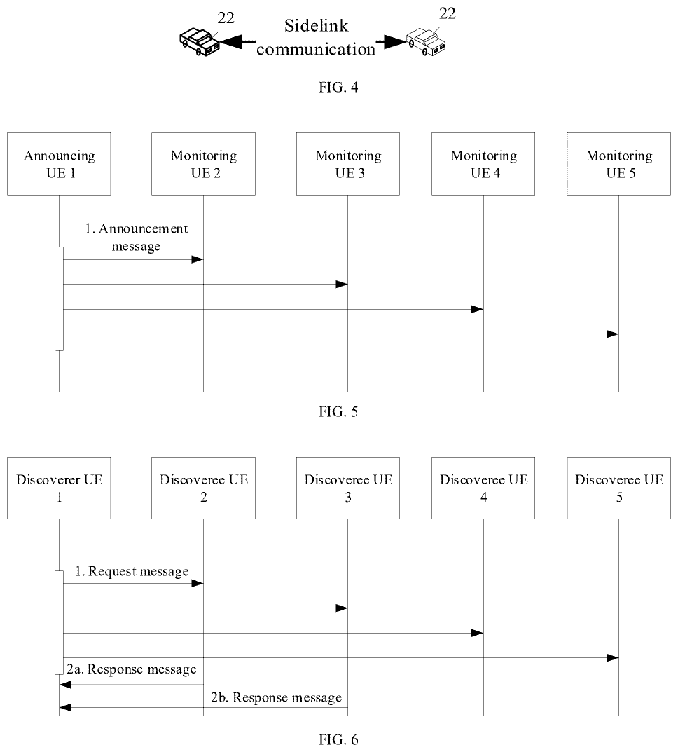

FIG. 4: In the case of out-of-coverage sidelink communication, all terminals 22 performing sidelink communication are located outside the network coverage area. All terminals 22 determine the sidelink configuration based on pre-configuration information and perform sidelink communication.

### SL Positioning

As illustrated in FIG. 2, in an in-coverage (IC) scenario for SL positioning, an anchor UE and a target UE are both in a state of connection with the 5G system. In this case, the configuration of SL-PRS is controlled by the LMF and/or gNB. SL positioning assistance information between the target UE and the anchor UE is uploaded to the LMF network element. The LMF performs unified aggregation and calculates the result, thereby achieving positioning.

As illustrated in FIG. 3, in a partial-coverage (PC) scenario for SL positioning, a portion of the anchor UE and target UE is located in the IC scenario, while another portion is located in an out-of-coverage (OOC) scenario. In this case, it is necessary to consider whether the configuration of SL-PRS still requires control by the LMF and/or gNB. SL positioning assistance information between the target UE and the anchor UE that requires LMF control is uploaded to the LMF network element. The LMF performs unified aggregation and calculates the result, thereby achieving positioning.

As illustrated in FIG. 4, in an out-of-coverage (OOC) scenario for SL positioning, the anchor UE and the target UE are both in a state of no connection with the 5G system. In this case, the SL-PRS of the anchor UE and the target UE is not controlled by the LMF and/or gNB. In the OOC scenario, the 5G system completes positioning by having the anchor UE perform a measurement on the SL-PRS transmitted by the target UE, or the target UE perform a measurement on the SL-PRS transmitted by the anchor UE, in combination with the position information of the anchor UE itself. The target UE needs to discover and select a UE as the SL positioning server UE, and transmit the SL positioning assistance information between the target UE, the anchor UE, and the SL positioning server UE to the SL positioning server UE. The SL positioning server UE performs unified aggregation and calculates the result, thereby achieving positioning.

In the related art, absolute positioning is supported; that is, the absolute position of the target UE is acquired. For SL positioning, however, relative positioning is an important part of the functionality. The target UE can acquire the position information of the target UE relative to the anchor UE, such as the distance and angle relative to the anchor UE.

### SL Discovery Process (Discovery)

### Model A Discovery (“I am Here”)

As illustrated in FIG. 5, the model defines two roles for UEs participating in discovery: 1. Announcing UE: A UE that is configured to announce, over an announcement message, certain information, which can be used by neighbor UEs with discovery authorization; 2. Monitoring UE: A UE that monitors certain information of interest near the announcing UE. In the model, the announcing UE 1 broadcasts an announcement message at predefined discovery intervals. A monitoring UE that is interested in the announcement message reads and processes the discovery message. Because the announcing UE will broadcast information about itself, the model is equivalent to “I am here”.
In process 1, the announcing UE (UE-1) transmits a ranging/SL positioning announcement message.
The ranging/SL positioning announcement message includes a type of discovery message, a security protection element, RSPP metadata information, and a user information ID of the announcing UE.
A destination layer-2 ID is configured for transmitting the ranging/SL positioning announcement message.
A source layer-2 ID for transmitting the ranging/SL positioning announcement message is allocated by the announcing UE itself. The announcing UE only transmits the announcement message when the announcing UE is authorized as the corresponding UE role in the RSPP metadata information.
For the announcing UE that is an anchor UE (located UE) capable of acquiring its own position, the ranging/SL positioning announcement message further includes the serving PLMN of the announcing UE.
The user information ID of the announcing UE is an application layer ID of the announcing UE.
The monitoring UE determines the destination layer-2 ID for signaling reception based on the configuration mentioned above.
The monitoring UE selects the announcing UE based on the information received in process 1.

In some embodiments, RSPP metadata information (for example, the role of the announcing UE) is included as metadata in the announcement message. In some embodiments, the role of the announcing UE includes an anchor UE, a target UE, an SL positioning server UE, and an anchor UE capable of acquiring its own position.

In some embodiments, the anchor UE capable of acquiring its own position refers to an anchor UE with a known position or an anchor UE capable of acquiring its own position using Uu positioning, and may also be referred to as an SL reference UE.

### Model B Discovery (“Who is There”/“are You There”)

As illustrated in FIG. 6, the model defines two roles for the UEs participating in discovery: 1. Discoverer UE: The discoverer UE transmits a request message, which contains certain information regarding what the discoverer UE is interested in discovering. 2. Discoveree UE: A UE receiving the request message may respond with some information related to the request message from the discoverer UE. Because the discoverer UE transmits information regarding other UEs from which the discoverer UE wishes to receive a response, the information may be a ProSe application identifier corresponding to one group, the members of which may respond. Therefore, the model is equivalent to “Who is there/Are you there”.
In process 1, the discoverer UE (UE-1) transmits a ranging/SL positioning request message. The ranging/SL positioning request message includes a type of discovery message, a security protection element, optionally a user information ID of the discoverer UE, target information, user information ID of the discoverer UE, and optionally the RSPP metadata information.
A destination layer-2 ID is configured for transmitting the ranging/SL positioning request message.
A source layer-2 ID for transmitting the ranging/SL positioning request message is allocated by the discoverer UE itself.
The discoveree UE only transmits a response message if the discoveree UE is authorized as the corresponding UE role in the request message.
In a case where the role of the discoveree UE is a located UE, the ranging/SL positioning response message further includes the serving PLMN of the discoveree UE.
The user information ID of the discoverer UE is an application layer ID of the discoverer UE.
The user information ID of the discoveree UE is used to identify a specific UE that the discoverer UE wants to discover, and the specific UE is identified by an application layer ID of the discoveree UE.
The discoveree UE determines the destination layer-2 ID for signaling reception based on the configuration mentioned above.

In some embodiments, RSPP metadata information (for example, a specific UE role to be discovered) is included as metadata in the request message. In some embodiments, the specific UE role to be discovered includes an anchor UE, a target UE, an SL positioning server UE, and an anchor UE capable of acquiring its own position.
In process 2, the discoveree UE matching the ranging/SL positioning request message (for example, RSPP metadata information) responds to the discoverer UE with a ranging/SL positioning response message. The ranging/SL positioning response message includes a type of discovery message, a security protection element, RSPP metadata information, and a user information ID of the discoveree UE.
A source layer-2 ID is configured for transmitting the ranging/SL positioning response message.
A destination layer-2 ID is set as the source layer-2 ID of the received ranging/SL positioning request message.
The user information ID of the discoveree UE is an application layer ID of the discoveree UE.

In some embodiments, RSPP metadata information (for example, the role of the discoveree UE) is included as metadata in the response message. In some embodiments, the role of the discoveree UE includes an anchor UE, a target UE, an SL positioning server UE, and an anchor UE capable of acquiring its own position.

### SL Positioning Procedure

In some embodiments, it is stipulated that in the ranging/SL positioning process, a UE-only operation or a network-based operation is adopted.

In some embodiments, the UE-only operation is applicable in the following situations.
The NG-RAN serves neither the target UE nor the anchor UE.
The 5GC network does not support the network-based operation: In a case where the 5GC network does not support the network-based operation, an indication as to whether the UE is permitted to perform ranging/SL positioning using the UE-only operation is carried in the policy/parameters provided to the UE. The target UE will consider this when initiating the UE-only operation process.
The SL-MO-LR request is rejected by the network.

In some embodiments, for any other cases, the network-based operation is applicable.

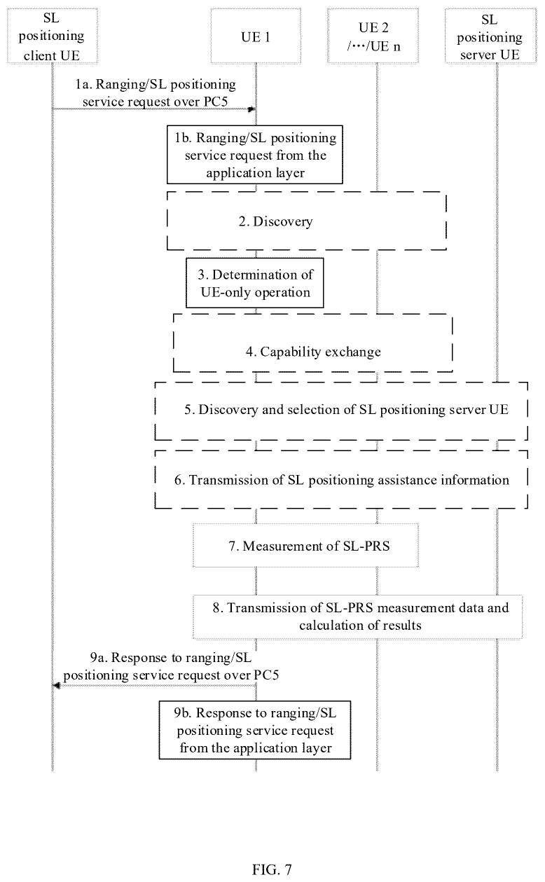

FIG. 7 illustrates a schematic diagram of an SL positioning procedure according to some embodiments of the present disclosure. FIG. 7 includes an SL positioning client UE, UE 1, UE 2/ . . . /UE n, and an SL positioning server UE. UE 1 is also referred to as the target UE; UE 2/ . . . /UE n are also referred to as anchor UEs; and the SL positioning server UE is also referred to as the server UE. Relevant processes of the SL positioning procedure are briefly described hereinafter.

In process 1, UE 1 receives a ranging/SL positioning service request.

In some embodiments, process 1 is implemented as process 1a or 1b.

In process 1a, the SL positioning client UE transmits a ranging/SL positioning service request from PC5 to UE 1.

In some embodiments, during the exposure of the ranging/SL positioning service over PC5, the SL positioning client UE is positioned over PC5. That is, the SL positioning client transmits the ranging/SL positioning service request to UE 1 over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of UE 1, the user information of UE 2/ . . . /UE n, and the ranging/SL positioning QoS information.

In process 1b, UE 1 receives a ranging/SL positioning service request from an application layer.

In some embodiments, UE 1 receives the ranging/SL positioning service request from the application layer.

In some embodiments, the ranging/SL positioning service request includes a result type and required QoS. The result type includes an absolute position, a relative position, or ranging information.

In process 2, UE 1 discovers UE 2/ . . . /UE n.

In some embodiments, UE 2/ . . . /UE n serve as anchor UEs. For example, UE 2/ . . . /UE n are configured to transmit SL-PRS to UE 1, and UE 1 performs an SL-PRS measurement; or UE 1 is configured to transmit SL-PRS to UE 2/ . . . /UE n, and UE 2/ . . . /UE n each performs an SL-PRS measurement.

In process 3, UE 1 determines a UE-only operation.

In some embodiments, in a case where any of UE 1/ . . . /UE n is not served by NG-RAN, or in a case where a serving network does not support ranging/SL positioning, it is determined to apply the UE-only operation. In some embodiments, in a case where UE 1/ . . . /UE n are in an OOC scenario, the UE-only operation will be determined.

In process 4, UE 1 and UE 2/ . . . /UE n perform capability exchange.

In some embodiments, process 4 is performed during processes 5 and 6 under the coordination of the SL positioning server UE.

In process 5, UE 1 discovers and selects the SL positioning server UE.

In some embodiments, in a case where UE 1 does not support the SL positioning server UE function, UE 1 discovers and selects the SL positioning server UE. The SL positioning server UE may be a UE among UE 2/ . . . /UE n or may be another separate UE.

In some embodiments, in a case where the SL positioning server UE is a UE among UE 2/ . . . /UE n or another separate UE, UE 1 discovers and selects the SL positioning server UE and requests the SL positioning server UE to participate in ranging/SL positioning.

In process 6, SL positioning assistance information is transmitted.

In some embodiments, SL positioning assistance information is transmitted among UE 1, UE 2/ . . . /UE n, and the SL positioning server UE.

In process 7, SL-PRS is measured.

In some embodiments, SL-PRS is measured between UE 1 and UE 2/ . . . /UE n.

In some embodiments, SL-PRS is measured among UE 2/ . . . /UE n.

In process 8, SL-PRS measurement data is transmitted, and a ranging/SL positioning result is calculated.

In some embodiments, UE 1 and/or UE 2/ . . . /UE n transmit SL-PRS measurement data to the SL positioning server UE. The SL positioning server UE calculates the ranging/SL positioning result and transmits the ranging/SL positioning result to UE 1. Based on the result type received in process 1, the SL positioning server UE calculates the absolute position, the relative position, or the ranging information.

In some embodiments, in a case where UE 1 supports the SL positioning server UE function, UE 2/ . . . /UE n transmit the SL-PRS measurement data to UE 1, and UE 1 calculates the ranging/SL positioning result. Based on the result type received in process 1, UE 1 calculates the absolute position, the relative position, or the ranging information.

In some embodiments, UE 1 transmits SL-PRS to UE 2/ . . . /UE n, and UE 2/ . . . /UE n measure the SL-PRS. UE 2/ . . . /UE n transmit the respective SL-PRS measurement data thereof to the SL positioning server UE. The SL positioning server UE performs positioning of UE 2/ . . . /UE n based on the SL-PRS measurement data and calculates the absolute position, the relative position, or the ranging information of UE 1.

In process 9, UE 1 responds to the ranging/SL positioning service request.

In process 9a, UE 1 responds to the ranging/SL positioning service request transmitted by the SL positioning client UE over PC5.

In process 9b, UE 1 responds to the ranging/SL positioning service request from the application layer.

### Discovery and Selection of SL Positioning Server UE

In some embodiments, in a case where the target UE meets one or more of the following criteria or conditions, the target UE discovers and selects the SL positioning server UE.

The target UE and the anchor UE currently do not have a network service supporting ranging/SL positioning. For example, the target UE and the anchor UE are out of coverage, or the serving network does not support ranging/SL positioning. Ranging/SL positioning support is configured in the AMF based on the network capability. In a case where the AMF receives the capability where the UE supports ranging/SL positioning, the AMF may include a ranging/SL position support indicator in a registration accept message to indicate that the serving network supports ranging/SL positioning. The anchor UE and the target UE may indicate to each other whether the serving network thereof supports ranging/SL positioning. In a case where no available non-access stratum (NAS) connection is present for the UE, the indication that the serving network does not support ranging/SL positioning may be reused for mutual notification.

The target UE cannot support the SL positioning server UE function.

The anchor UE cannot support the SL positioning server UE function.

In some embodiments, in a case where the UE is authorized as an SL positioning server UE in a given PLMN, the UE indicates its role “SL positioning server UE” in a supported role list during its discovery period.

In some embodiments, the target UE needs to discover and select the SL positioning server UE in the same or different serving PLMN of the target UE and the anchor UE.

As described above, in the OOC scenario, to support SL positioning service, in a case where the target UE does not support the SL positioning server UE function, the target UE needs to discover and select an SL positioning server UE. The following introduces two selection modes separately; and different embodiments may use either of the two selection modes.

### Selection Mode One: Based on Unicast Signaling

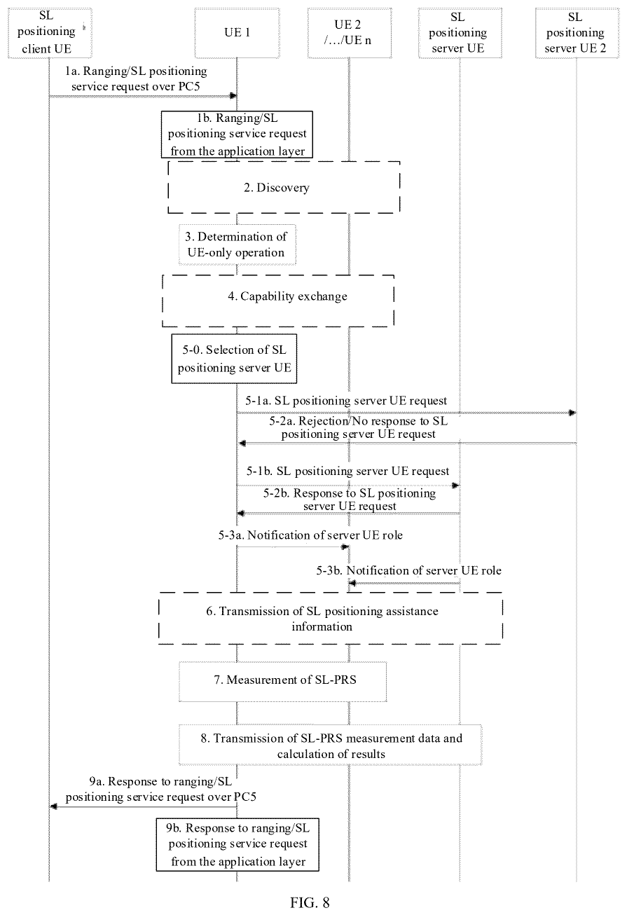

FIG. 8 illustrates a schematic diagram of an SL positioning procedure according to some embodiments of the present disclosure. FIG. 8 includes an SL positioning client UE, UE 1, UE 2/ . . . /UE n, and an SL positioning server UE. UE 1 is also referred to as the target UE; UE 2/ . . . /UE n are also referred to as anchor UEs; the SL positioning server UE is also referred to as the server UE. Processes of the SL positioning procedure are briefly described hereinafter.

In process 1, UE 1 receives a ranging/SL positioning service request.

In some embodiments, process 1 is implemented as process 1a or 1b.

In process 1a, the SL positioning client UE transmits a ranging/SL positioning service request from PC5 to UE 1.

In some embodiments, during the exposure of the ranging/SL positioning service over PC5, the SL positioning client UE is positioned over PC5. That is, the SL positioning client transmits the ranging/SL positioning service request to UE 1 over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of UE 1, the user information of UE 2/ . . . /UE n, and the ranging/SL positioning QoS information.

In process 1b, UE 1 receives a ranging/SL positioning service request from an application layer.

In some embodiments, UE 1 receives the ranging/SL positioning service request from the application layer.

In some embodiments, the ranging/SL positioning service request includes a result type and required QoS. The result type includes an absolute position, a relative position, or ranging information.

In process 2, UE 1 discovers UE 2/ . . . /UE n.

In some embodiments, UE 2/ . . . /UE n serve as anchor UEs. For example, UE 2/ . . . /UE n are configured to transmit SL-PRS to UE 1, and UE 1 performs an SL-PRS measurement; or UE 1 is configured to transmit SL-PRS to UE 2/ . . . /UE n, and UE 2/ . . . /UE n each performs an SL-PRS measurement.

In process 3, UE 1 determines a UE-only operation.

In some embodiments, in a case where any of UE 1/ . . . /UE n is not served by NG-RAN, or in a case where a serving network does not support ranging/SL positioning, it is determined to apply the UE-only operation. In some embodiments, in a case where UE 1/ . . . /UE n are in an OOC scenario, the UE-only operation will be determined.

In process 4, UE 1 and UE 2/ . . . /UE n perform capability exchange.

In some embodiments, process 4 is performed during processes 5 and 6 under the coordination of the SL positioning server UE.

In some embodiments, process 4 is implemented as processes 4a and 4b.

In process 4a, UE 1 transmits a capability request message to UE 2/ . . . /UE n.

In some embodiments, the capability request message is used to instruct a first UE, among UE 2/ . . . /UE n, to return at least one of the following pieces of information to UE 1:
reference signal received power (RSRP) information between the first UE and UE 2/ . . . /UE n;
information indicating whether an SL unicast communication is establishable between the first UE and UE 2/ . . . /UE n; or
the number of SL unicast communications establishable between the first UE and UE 2/ . . . /UE n.

In some embodiments, the capability request message is used to instruct a first UE, among UE 2/ . . . /UE n, to return at least one of the following pieces of information to UE 1:
RSRP information between the first UE and UE 2/ . . . /UE n in a UE list;
information indicating whether an SL unicast communication establishable between the first UE and UE 2/ . . . /UE n in the UE list; or
the number of SL unicast communications establishable between the first UE and UE 2/ . . . /UE n in the UE list;
wherein UE 2/ . . . /UE n in the UE list are a subset of UE 2/ . . . /UE n.

In some embodiments, the first UE is one UE among UE 2/ . . . /UE n, and UE 2/ . . . /UE n are UEs performing capability exchange with UE 1.

In process 4b, UE 1 receives a capability response message from UE 2/ . . . /UE n.

In some embodiments, the capability response message is further used to carry at least one of the following pieces of information of the first UE among UE 2/ . . . /UE n:
RSRP information between the first UE and UE 2/ . . . /UE n;
information indicating whether an SL unicast communication establishable between the first UE and UE 2/ . . . /UE n; or
the number of SL unicast communications establishable between the first UE and UE 2/ . . . /UE n.

In some embodiments, the capability response message is further used to carry at least one of the following pieces of information of the first UE among UE 2/ . . . /UE n:
RSRP information between the first UE and UE 2/ . . . /UE n in a UE list;
information indicating whether an SL unicast communication is establishable between the first UE and UE 2/ . . . /UE n in the UE list; or
the number of SL unicast communications establishable between the first UE and UE 2/ . . . /UE n in the UE list;
wherein UE 2/ . . . /UE n in the UE list are a subset of UE 2/ . . . /UE n.

In process 5, UE 1 discovers and selects the SL positioning server UE.

In process 5-0, UE 1 determines the SL positioning server UE based on the capability response message in process 4.

In process 5-1a, UE 1 transmits an SL positioning server UE request message to the SL positioning server UE.

In process 5-2a, the SL positioning server UE rejects/does not respond to the SL positioning server UE request message.

In process 5-1b, UE 1 transmits the SL positioning server UE request message to an SL positioning server UE 2.

In process 5-2b, the SL positioning server UE 2 responds to the SL positioning server UE request message.

In process 5-3a, UE 1 transmits a server UE role notification message to UE 2/ . . . /UE n.

In process 5-3b, the SL positioning server UE transmits a server UE role notification message to UE 2/ . . . /UE n.

In some embodiments, the server UE role notification message carries identification information of the SL positioning server UE.

In some embodiments, the server UE role notification message further carries identification information of UE 1.

In some embodiments, the server UE role notification message carries at least one of the following pieces of information.
SL positioning assistance information;
announcement message for the SL discovery process;
a request message for the SL discovery process; or
NAS signaling.

In some embodiments, process 5-3a or 5-3b is optionally performed.

In process 6, SL positioning assistance information is transmitted.

In some embodiments, SL positioning assistance information is transmitted among UE 1, UE 2/ . . . /UE n, and the server UE.

In process 7, SL-PRS is measured.

In some embodiments, SL-PRS is measured between UE 1 and UE 2/ . . . /UE n.

In some embodiments, SL-PRS is measured among UE 2/ . . . /UE n.

In process 8, SL-PRS measurement data is transmitted, and a ranging/SL positioning result is calculated.

In some embodiments, UE 1 and/or UE 2/ . . . /UE n transmit SL-PRS measurement data to the SL positioning server UE. The SL positioning server UE calculates the ranging/SL positioning result and transmits the ranging/SL positioning result to UE 1. Based on the result type received in process 1, the SL positioning server UE calculates the absolute position, the relative position, or the ranging information.

In some embodiments, in a case where UE 1 supports the SL positioning server UE function, UE 2/ . . . /UE n transmit the SL-PRS measurement data to UE 1, and UE 1 calculates the ranging/SL positioning result. Based on the result type received in process 1, UE 1 calculates the absolute position, the relative position, or the ranging information.

In some embodiments, UE 1 transmits SL-PRS to UE 2/ . . . /UE n, and UE 2/ . . . /UE n measure the SL-PRS. UE 2/ . . . /UE n transmit the respective SL-PRS measurement data thereof to the SL positioning server UE. The SL positioning server UE performs positioning of UE 2/ . . . /UE n based on the SL-PRS measurement data and calculates the absolute position, the relative position, or the ranging information of UE 1.

In process 9, UE 1 responds to the ranging/SL positioning service request.

In process 9a, UE 1 responds to the ranging/SL positioning service request transmitted by the SL positioning client UE over PC5.

In process 9b, UE 1 responds to the ranging/SL positioning service request from the application layer.

By adopting selection mode one in the embodiments, UE 1 first determines the SL positioning server UE. Each time, UE 1 only needs to transmit the SL positioning server UE request message to one SL positioning server UE it has determined, which can save signaling interactions and reduce signaling overhead. Because the SL positioning server UE may reject/not respond to the SL positioning server UE request message transmitted by UE 1, mode one in the embodiments may result in the problem of a longer duration for determining the SL positioning server UE.

### Selection Mode Two: Based on SL Discovery

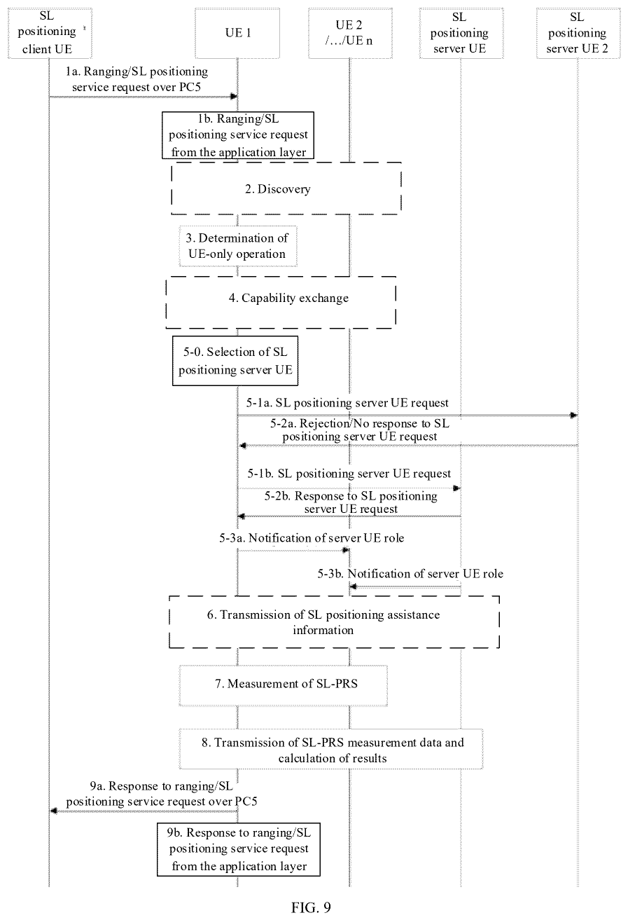

FIG. 9 illustrates a schematic diagram of an SL positioning procedure according to some embodiments of the present disclosure. FIG. 9 includes an SL positioning client UE, UE 1, UE 2/ . . . /UE n, and an SL positioning server UE. UE 1 is also referred to as the target UE; UE 2/ . . . /UE n are also referred to as anchor UEs; and the SL positioning server UE is also referred to as the server UE. Processes of the SL positioning procedure are briefly described hereinafter.

In process 1, UE 1 receives a ranging/SL positioning service request.

In some embodiments, process 1 is implemented as process 1a or 1b.

In process 1a, the SL positioning client UE transmits a ranging/SL positioning service request to UE 1 from PC5.

In some embodiments, during the exposure of the ranging/SL positioning service over PC5, the SL positioning client UE is positioned over PC5. That is, the SL positioning client transmits the ranging/SL positioning service request to UE 1 over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of UE 1, the user information of UE 2/ . . . /UE n, and the ranging/SL positioning QoS information.

In process 1b, UE 1 receives a ranging/SL positioning service request from an application layer.

In some embodiments, UE 1 receives the ranging/SL positioning service request from the application layer.

In some embodiments, the ranging/SL positioning service request includes a result type and required QoS. The result type includes an absolute position, a relative position, or ranging information.

In process 2, UE 1 discovers UE 2/ . . . /UE n.

In some embodiments, UE 2/ . . . /UE n serve as anchor UEs. For example, UE 2/ . . . /UE n are configured to transmit SL-PRS to UE 1, and UE 1 performs an SL-PRS measurement; or UE 1 is configured to transmit SL-PRS to UE 2/ . . . /UE n, and UE 2/ . . . /UE n each performs an SL-PRS measurement.

In process 3, UE 1 determines a UE-only operation.

In some embodiments, in a case where any of UE 1/ . . . /UE n is not served by NG-RAN, or in a case where a serving network does not support ranging/SL positioning, it is determined to apply the UE-only operation. In some embodiments, in a case where UE 1/ . . . /UE n are in an OOC scenario, the UE-only operation will be determined.

In process 4, UE 1 and UE 2/ . . . /UE n perform capability exchange.

In some embodiments, process 4 is performed during processes 5 and 6 under the coordination of the SL positioning server UE.

In process 5, UE 1 discovers and selects the SL positioning server UE.

In some embodiments, process 5 is implemented as at least one of process 5-0, 5-1, 5-2, or 5-3. Process 5-1 may be implemented as process 5-1a and/or process 5-1b; process 5-2 may be implemented as process 5-2a and/or process 5-2b; process 5-3 may be implemented as process 5-3a and/or process 5-3b.

In process 5-1, UE 1 transmits the SL positioning server UE request message to UE 2/ . . . /UE n, the SL positioning server UE, and the SL positioning server UE 2.

In some embodiments, UE 1 transmits the SL positioning server UE request message to UE 2/ . . . /UE n, the SL positioning server UE, and the SL positioning server UE 2 by broadcasting.

In some embodiments, the SL positioning server UE request message is used to instruct a second UE among UE 2/ . . . /UE n, the SL positioning server UE, and the SL positioning server UE 2 to return at least one of the following pieces of information to the target UE:
RSRP information between the second UE and UE 2/ . . . /UE n;
information indicating whether an SL unicast communication is establishable between the second UE and UE 2/ . . . /UE n; or
the number of SL unicast communications establishable between the second UE and UE 2/ . . . /UE n.

In some embodiments, the SL positioning server UE request message is further used to instruct a second UE among UE 2/ . . . /UE n, the SL positioning server UE, and the SL positioning server UE 2 to return at least one of the following pieces of information to the target UE:
RSRP information between the second UE and UE 2/ . . . /UE n in the UE list;
information indicating whether an SL unicast communication is establishable between the second UE and UE 2/ . . . /UE n in the UE list; or
the number of SL unicast communications establishable between the second UE and UE 2/ . . . /UE n in the UE list.

UE 2/ . . . /UE n in the UE list are a subset of UE 2/ . . . /UE n.

In some embodiments, the second UE is one of candidate UEs. A candidate UE is a UE that is a candidate to become the SL positioning server UE. The candidate UEs include at least one of UE 2/ . . . /UE n, the SL positioning server UE, or the SL positioning server UE 2.

In process 5-2, UE 2/ . . . /UE n, the SL positioning server UE, and the SL positioning server UE 2 respond to the SL positioning server UE request message.

In some embodiments, the SL positioning server UE response message is used to carry at least one of the following pieces of information of the second UE among UE 2/ . . . /UE n, the SL positioning server UE, and the SL positioning server UE 2:
RSRP information between the second UE and UE 2/ . . . /UE n;
information indicating whether an SL unicast communication is establishable between the second UE and UE 2/ . . . /UE n; or
the number of SL unicast communications establishable between the second UE and UE 2/ . . . /UE n.

In some embodiments, the SL positioning server UE response message is used to carry at least one of the following pieces of information of the second UE among UE 2/ . . . /UE n, the SL positioning server UE, and the SL positioning server UE 2:
RSRP information between the second UE and UE 2/ . . . /UE n in the UE list;
information indicating whether an SL unicast communication is establishable between the second UE and UE 2/ . . . /UE n in the UE list; or
the number of SL unicast communications establishable between the second UE and UE 2/ . . . /UE n in the UE list.

UE 2/ . . . /UE n in the UE list are a subset of UE 2/ . . . /UE n.

In process 5-3, UE 1 determines the SL positioning server UE based on the SL positioning server UE response message from process 5-2.

In process 5-4, UE 1 transmits an SL positioning server UE confirmation message to the SL positioning server UE.

In process 5-5, UE 1 transmits a server UE role notification message to UE 2/ . . . /UE n.

In some embodiments, the server UE role notification message carries identification information of the SL positioning server UE.

In some embodiments, the server UE role notification message further carries identification information of UE 1.

In some embodiments, the server UE role notification message carries at least one of the following pieces of information.
SL positioning assistance information;
announcement message for the SL discovery process;
a request message for the SL discovery process; or
NAS signaling.

In process 6, SL positioning assistance information is transmitted.

In some embodiments, SL positioning assistance information is transmitted among UE 1, UE 2/ . . . /UE n, and the SL positioning server UE.

In process 7, SL-PRS is measured.

In some embodiments, SL-PRS is measured between UE 1 and UE 2/ . . . /UE n.

In some embodiments, SL-PRS is measured among UE 2/ . . . /UE n.

In process 8, SL-PRS measurement data is transmitted, and a ranging/SL positioning result is calculated.

In some embodiments, UE 1 and/or UE 2/ . . . /UE n transmit SL-PRS measurement data to the SL positioning server UE. The SL positioning server UE calculates the ranging/SL positioning result and transmits the ranging/SL positioning result to UE 1. Based on the result type received in process 1, the SL positioning server UE calculates the absolute position, the relative position, or the ranging information.

In some embodiments, in a case where UE 1 supports the SL positioning server UE function, UE 2/ . . . /UE n transmit the SL-PRS measurement data to UE 1, and UE 1 calculates the ranging/SL positioning result. Based on the result type received in process 1, UE 1 calculates the absolute position, the relative position, or the ranging information.

In some embodiments, UE 1 transmits SL-PRS to UE 2/ . . . /UE n, and UE 2/ . . . /UE n measure the SL-PRS. UE 2/ . . . /UE n transmit the respective SL-PRS measurement data thereof to the SL positioning server UE. The SL positioning server UE performs positioning of UE 2/ . . . /UE n based on the SL-PRS measurement data and calculates the absolute position, the relative position, or the ranging information of UE 1.

In process 9, UE 1 responds to the ranging/SL positioning service request.

In process 9a, UE 1 responds to the ranging/SL positioning service request transmitted by the SL positioning client UE over PC5.

In process 9b, UE 1 responds to the ranging/SL positioning service request from the application layer.

By adopting selection mode two in the embodiments, UE 1 transmits the SL positioning server UE request message to UE 2/ . . . /UE n, the SL positioning server UE, and the SL positioning server UE 2, such that the SL positioning server UE can be determined quickly. Because UE 1 needs to transmit the SL positioning server UE request messages to a plurality of UEs each time, mode two in the embodiments may result in frequent signaling interactions and high signaling overhead.

The following introduces two selection modes for the target UE to select the SL positioning server UE separately. Different embodiments may use either of the two selection modes.

### Selection Mode One: Based on Unicast Signaling

Exemplarily, mode one in the embodiments is implemented based on the model A discovery process.

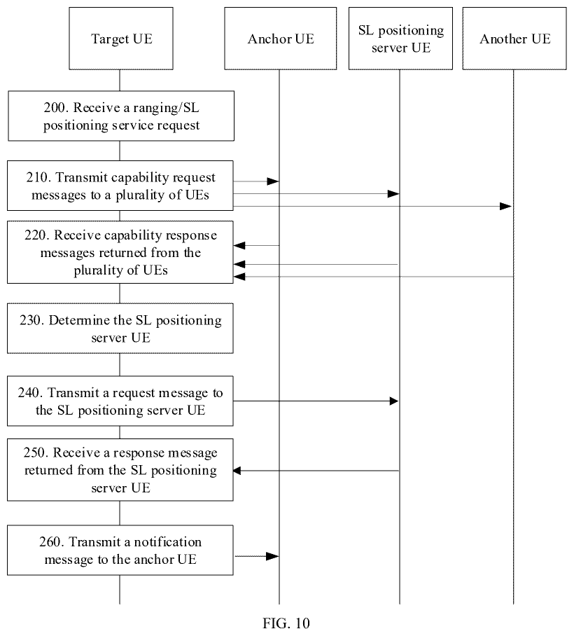

FIG. 10 illustrates a schematic diagram of a communication method applicable to an SL positioning service scenario according to some embodiments of the present disclosure. The method is applicable to a target UE and includes at least one of the following processes.

In process 200, the target UE receives a ranging/SL positioning service request.

In some embodiments, the target UE receives the ranging/SL positioning service request from the SL positioning client UE.

In some embodiments, during the exposure of the ranging/SL positioning service over PC5, the SL positioning client UE is positioned over PC5. That is, the SL positioning client transmits a ranging/SL positioning service request to the target UE over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of the target UE, the user information of the anchor UE, and the ranging/SL positioning QoS information.

In some embodiments, the target UE receives the ranging/SL positioning service request from the application layer.

In some embodiments, the ranging/SL positioning service request includes a result type and required QoS. The result type includes an absolute position, a relative position, or ranging information.

In process 210, the target UE transmits capability request messages to a plurality of UEs.

In some embodiments, during the capability exchange process, the target UE transmits the capability request messages to a plurality of UEs.

In some embodiments, the capability exchange process is also referred to as at least one of an exchange process, a capability interaction process, an SL positioning capability exchange process, or an SL positioning capability interaction process.

In some embodiments, the capability request message is also referred to as at least one of a request message, an exchange request message, an interaction request message, a capability exchange request message, a capability interaction request message, an SL positioning capability request message, an SL positioning capability exchange request message, or an SL positioning capability interaction request message.

In some embodiments, the plurality of UEs include the anchor UE and/or other UEs except the anchor UE and the target UE.

In some embodiments, the first UE is one UE among the plurality of UEs.

In some embodiments, the plurality of UEs are UEs performing capability exchange with the target UE.

In some embodiments, the capability request message is further used to instruct the first UE among the plurality of UEs to return at least one of the following pieces of information to the target UE:

RSRP information between the first UE and at least one anchor UE;
information indicating whether an SL unicast communication is establishable between the first UE and at least one anchor UE; or
the number of SL unicast communications establishable between the first UE and at least one anchor UE.

In some embodiments, each RSRP between the first UE and the anchor UE is represented by n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the first UE and the anchor UE is represented by a bit sequence (bitmap). Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE. The i^{th} anchor UE is one anchor UE among the anchor UEs.

In some embodiments, the bit value corresponding to the information indicating whether an SL unicast communication is establishable between the first UE and the anchor UE is 0, indicating that SL unicast communication cannot be established between the first UE and the anchor UE. The bit value corresponding to the information indicating whether an SL unicast communication is establishable between the first UE and the anchor UE is 1, indicating that an SL unicast communication is establishable between the first UE and the anchor UE.

In some embodiments, the bit value corresponding to the information indicating whether an SL unicast communication is establishable between the first UE and the anchor UE is 0, indicating that an SL unicast communication is establishable between the first UE and the anchor UE. The bit value corresponding to the information indicating whether an SL unicast communication is establishable between the first UE and the anchor UE is 1, indicating that SL unicast communication cannot be established between the first UE and the anchor UE.

In some embodiments, the indication information is determined based on a comparison of magnitude between the RSRP information and RSRP threshold information.

In some embodiments, the capability request message further carries the RSRP threshold information.

In some embodiments, in a case where the RSRP between the first UE and the anchor UE is greater than the RSRP threshold, the requirement for establishing SL unicast communication is met, and an SL unicast communication is establishable between the first UE and the anchor UE. The indication information is used to indicate that an SL unicast communication is establishable between the first UE and the anchor UE.

In some embodiments, in a case where the RSRP between the first UE and the anchor UE is less than the RSRP threshold, the requirement for establishing SL unicast communication is not met, and SL unicast communication cannot be established between the first UE and the anchor UE. The indication information is used to indicate that SL unicast communication cannot be established between the first UE and the anchor UE.

In some embodiments, in the case where the RSRP between the first UE and the anchor UE is greater than the RSRP threshold, the bit value corresponding to the indication information is 1. In the case where the RSRP between the first UE and the anchor UE is less than the RSRP threshold, the bit value corresponding to the indication information is 0.

In some embodiments, in the case where the RSRP between the first UE and the anchor UE is greater than the RSRP threshold, the bit value corresponding to the indication information is 0. In the case where the RSRP between the first UE and the anchor UE is less than the RSRP threshold, the bit value corresponding to the indication information is 1.

In some embodiments, the number of SL unicast communications establishable between the first UE and the anchor UE is represented by a bit sequence. Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE. The i^{th} anchor UE is one anchor UE among the anchor UEs.

In some embodiments, the number of SL unicast communications establishable between the first UE and the anchor UE is represented by a codepoint. The number of SL unicast communications establishable between the first UE and the anchor UE is in a one-to-one correspondence with the value of the codepoint.

In some embodiments, a binary value corresponding to three bits forms one codepoint, and each codepoint represents a quantity of SL unicast communications establishable between the first UE and the anchor UE. For example, 001 indicates that the number of SL unicast communications establishable between the first UE and the anchor UE is 1, and 010 indicates that the number of SL unicast communications establishable between the first UE and the anchor UE is 2.

In some embodiments, the corresponding relationship between the number of SL unicast communications establishable between the first UE and the anchor UE and the bit sequence and/or codepoint is determined through negotiation, stipulated by a protocol, or indicated by the target UE in the capability request message.

In some embodiments, the capability request message is further used to instruct the first UE among the plurality of UEs to return at least one of the following pieces of information to the target UE:
RSRP information between the first UE and each anchor UE in the UE list;
information indicating whether an SL unicast communication is establishable between the first UE and each anchor UE in the UE list; or
the number of SL unicast communications establishable between the first UE and all anchor UEs in the UE list.

The anchor UEs in the UE list are a subset of the anchor UEs.

In some embodiments, the UE list is a subset of a set formed by at least one anchor UE.

In some embodiments, the first UE is one of a plurality of UEs.

In some embodiments, the plurality of UEs are UEs performing capability exchange with the target UE.

In some embodiments, the indication information is determined based on a comparison of magnitude between the RSRP information and RSRP threshold information.

In some embodiments, the capability request message further carries the RSRP threshold information.

In some embodiments, in a case where the RSRP between the first UE and the anchor UE in the UE list is greater than the RSRP threshold, the requirement for establishing SL unicast communication is met, and an SL unicast communication is establishable between the first UE and the anchor UE in the UE list. The indication information is used to indicate that an SL unicast communication is establishable between the first UE and the anchor UE in the UE list.

In some embodiments, in a case where the RSRP between the first UE and the anchor UE in the UE list is less than the RSRP threshold, the requirement for establishing SL unicast communication is not met, and SL unicast communication cannot be established between the first UE and the anchor UE in the UE list. The indication information is used to indicate that SL unicast communication cannot be established between the first UE and the anchor UE in the UE list.

In some embodiments, in the case where the RSRP between the first UE and the anchor UE in the UE list is greater than the RSRP threshold, the bit value corresponding to the indication information is 1. In the case where the RSRP between the first UE and the anchor UE in the UE list is less than the RSRP threshold, the bit value corresponding to the indication information is 0.

In some embodiments, in the case where the RSRP between the first UE and the anchor UE in the UE list is greater than the RSRP threshold, the bit value corresponding to the indication information is 0. In the case where the RSRP between the first UE and the anchor UE in the UE list is less than the RSRP threshold, the bit value corresponding to the indication information is 1.

In some embodiments, the number of SL unicast communications establishable between the first UE and the anchor UE in the UE list is represented by a bit sequence. Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE in the UE list. The i^{th} anchor UE is one anchor UE among the anchor UEs in the UE list.

In some embodiments, the number of SL unicast communications establishable between the first UE and the anchor UE in the UE list is represented by a codepoint. The number of SL unicast communications establishable between the first UE and the anchor UE in the UE list is in a one-to-one correspondence with the value of the codepoint.

In some embodiments, a binary value corresponding to three bits forms a codepoint, and each codepoint represents a quantity of SL unicast communications establishable between the first UE and the anchor UE in the UE list. For example, 001 indicates that the number of SL unicast communications establishable between the first UE and the anchor UE in the UE list is 1, and 010 indicates that the number of SL unicast communications establishable between the first UE and the anchor UE in the UE list is 2.

In some embodiments, the corresponding relationship between the number of SL unicast communications establishable between the first UE and the anchor UE in the UE list and the bit sequence and/or codepoint is determined by negotiation, stipulated by a protocol, or indicated by the target UE in the capability request message.

In some embodiments, the first UE among the plurality of UEs includes a UE among the anchor UEs, and/or a UE among other UEs except the anchor UE and the target UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is indicated using at least one of numbers, letters, symbols, or bits.

In some embodiments, process 210 is performed after process 2, in which UE 1 discovers UE 2/ . . . /UE n.

In some embodiments, process 210 is performed during process 4, in which UE 1 and UE 2/ . . . /UE n perform capability exchange.

In process 220, the target UE receives capability response messages from the plurality of UEs.

In some embodiments, during the capability exchange process, the target UE receives the capability response messages from the plurality of UEs.

In some embodiments, the capability exchange process is also referred to as at least one of an exchange process, a capability interaction process, an SL positioning capability exchange process, or an SL positioning capability interaction process.

In some embodiments, the capability response message is also referred to as at least one of a response message, an exchange response message, an interaction response message, a capability exchange response message, or a capability interaction response message.

In some embodiments, the plurality of UEs include the anchor UE and/or other UEs except the anchor UE and the target UE.

In some embodiments, the capability response message is further used to carry at least one of the following pieces of information of the first UE among the plurality of UEs:
RSRP information between the first UE and at least one anchor UE;
information indicating whether an SL unicast communication is establishable between the first UE and at least one anchor UE; or
the number of SL unicast communications establishable between the first UE and at least one anchor UE.

In some embodiments, the first UE is one of a plurality of UEs.

In some embodiments, the plurality of UEs are UEs performing capability exchange with the target UE.

In some embodiments, the capability response message is further used to carry at least one of the following pieces of information of the first UE among the plurality of UEs:
RSRP information between the first UE and each anchor UE in the UE list;
information indicating whether an SL unicast communication is establishable between the first UE and each anchor UE in the UE list; or
the number of SL unicast communications establishable between the first UE and all anchor UEs in the UE list.

The anchor UEs in the UE list are a subset of the anchor UEs.

In some embodiments, the UE list is a subset of a set formed by at least one anchor UE.

In some embodiments, the first UE is one of a plurality of UEs.

In some embodiments, the plurality of UEs are UEs performing capability exchange with the target UE.

In some embodiments, the first UE among the plurality of UEs includes the anchor UE, and/or a UE among other UEs except the anchor UE and the target UE.

In some embodiments, process 220 is performed after process 2, in which UE 1 discovers UE 2/ . . . /UE n.

In some embodiments, process 220 is performed during process 4, in which UE 1 and UE 2/ . . . /UE n perform capability exchange.

In process 230, the target UE determines the SL positioning server UE based on the capability response message.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the target UE calculates a mean RSRP of the first UE based on the RSRP information between the first UE and the anchor UE in the capability response information. The first UE with the largest mean RSRP is determined as the SL positioning server UE.

In some embodiments, the target UE determines the number of RSRPs greater than an RSRP threshold in the RSRP of the first UE based on the RSRP information between the first UE and the anchor UE in the capability response information. The first UE with the largest number of RSRPs greater than the RSRP threshold is determined as the SL positioning server UE.

In some embodiments, the target UE determines the number of anchor UEs capable of establishing an SL unicast communication with the first UE based on the information indicating whether an SL unicast communication is establishable between the first UE and the anchor UE in the capability response information. The first UE capable of establishing SL unicast communications with the largest number of anchor UEs is determined as the SL positioning server UE.

In some embodiments, the target UE determines the first UE capable of establishing SL unicast communications with the largest number of anchor UEs as the SL positioning server UE based on the number of SL unicast communications establishable between the first UE and the anchor UE in the response capability information.

In some embodiments, the SL positioning server UE is one of the following UEs:
a target UE;
an anchor UE; or
another UE other than the target UE and the anchor UE.

In some embodiments, process 230 is performed after process 2, in which UE 1 discovers UE 2/ . . . /UE n.

In some embodiments, process 230 is performed during process 4, in which UE 1 and UE 2/ . . . /UE n perform capability exchange.

In process 240, the target UE transmits a request message to the SL positioning server UE.

In some embodiments, the request message is used to request a receiver UE to serve as the SL positioning server UE.

In some embodiments, the receiver UE is also referred to as at least one of an SL positioning service receiver UE, an SL positioning receiver UE, an SL service receiver UE, a positioning receiver UE, or a positioning service receiver UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, process 240 is performed after process 2, in which UE 1 discovers UE 2/ . . . /UE n.

In some embodiments, process 240 is performed after process 4, in which UE 1 and UE 2/ . . . /UE n perform capability exchange.

In process 250, the target UE receives a response message from the SL positioning server UE.

In some embodiments, the response message is used to indicate whether the receiver UE agrees to serve as the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message includes a first bit, and a bit value of the first bit is used to indicate whether the receiver UE agrees to serve as the SL positioning server UE. The first bit is one of the bits corresponding to the response message.

In some embodiments, the bit value corresponding to the first bit being 0 indicates that the receiver UE does not agree to serve as the SL positioning server UE. The bit value corresponding to the first bit being 1 indicates that the receiver UE agrees to serve as the SL positioning server UE.

In some embodiments, the bit value corresponding to the first bit being 1 indicates that the receiver UE does not agree to serve as the SL positioning server UE. The bit value corresponding to the first bit being 0 indicates that the receiver UE agrees to serve as the SL positioning server UE.

In some embodiments, in the case where the response message indicates that the receiver UE does not agree to serve as the SL positioning server UE, the target UE re-determines the SL positioning server UE.

In some embodiments, in a case where the target UE does not receive a response message, the target UE re-determines the SL positioning server UE.

In process 260, the target UE transmits a notification message to the anchor UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message and/or request message to save signaling interaction.

In some embodiments, the notification message is carried in the metadata of the announcement message. For example, the role of the announcing UE is indicated as the target UE, and the server UE role is not indicated; the identification information of the SL positioning server UE is carried in the metadata to save signaling interaction.

In some embodiments, the target UE may have different positioning service requests. To further distinguish the positioning session or ranging/SL positioning service request to which the SL positioning server UE belongs, the notification message further carries positioning session identification information.

In some embodiments, the notification message is carried in the SL positioning assistance information. The SL positioning assistance information is transmitted by broadcasting or multicasting. The target UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, process 260 is performed after process 4, in which UE 1 and UE 2/ . . . /UE n perform capability exchange. In the embodiments, processes 210, 220, 230, 240, 250, and 260 are optional. In different embodiments, one or more of the processes may be omitted or replaced, and processes 210, 220, 230, 240, 250, and 260 may be performed in different orders or performed simultaneously.

Processes 210 and 220 may be implemented as an independent embodiment; processes 240 and 250 may be implemented as an independent embodiment; processes 230 and 260 may be implemented as an independent embodiment; processes 210 to 230 may be implemented as an independent embodiment; processes 210, 220, and 260 may be implemented as an independent embodiment; processes 240 to 260 may be implemented as an independent embodiment; processes 210, 220, 230, and 260 may be implemented as an independent embodiment; processes 230, 240, 250, and 260 may be implemented as an independent embodiment, which are not limited thereto.

Process 230 may be implemented as an independent embodiment, for example, independently implemented as a method for determining an SL positioning server UE or a method for determining information. Process 260 may be implemented as an independent embodiment, for example, independently implemented as a method for notifying an SL positioning server UE, a method for determining information, a method for transmitting information, or a method for transmitting a notification message. Processes 210 and 220 may be implemented as an independent embodiment, for example, independently implemented as a capability notification method or a method for determining capability information. Processes 240 and 250 may be implemented as an independent embodiment, for example, independently implemented as a method for determining information or a method for determining an SL positioning server UE. Processes 230 and 260 may be implemented as an independent embodiment, for example, independently implemented as a method for notifying an SL positioning server UE, a method for determining information, a method for transmitting information, or a method for transmitting a notification message. Processes 210 to 230 may be implemented as an independent embodiment, for example, independently implemented as a method for determining information or a method for determining an SL positioning server UE. Processes 210, 220, and 260 may be implemented as an independent embodiment, for example, independently implemented as a method for transmitting a notification message. Processes 240 to 260 may be implemented as an independent embodiment, for example, independently implemented as a method for transmitting a notification message. Processes 210, 220, 230, and 260 may be implemented as an independent embodiment, for example, independently implemented as a method for determining information or a method for transmitting a notification message. Processes 230, 240, 250, and 260 may be implemented as an independent embodiment, for example, independently implemented as a method for notifying an SL positioning server UE, a method for determining information, a method for transmitting information, or a method for transmitting a notification message.

Based on the selection mode one according to the embodiments, the target UE may determine an SL positioning server UE based on at least one of the following modes.

In mode one, the target UE determines the SL positioning server UE based on the RSRP information between the first UE and the anchor UE. In such a mode, the target UE can acquire rich assistance information, such that the target UE can evaluate the channel transmission quality between the first UE and each anchor UE, and thus determine the SL positioning server UE.

In mode two, the target UE determines the SL positioning server UE based on the information indicating whether an SL unicast communication is establishable between the first UE and the anchor UE. In such a mode, the target UE can evaluate the channel transmission quality between the first UE and each anchor UE, and thereby determine the SL positioning server UE. Compared with mode one, the signaling overhead is greatly reduced.

In mode three, the target UE determines the SL positioning server UE based on the number of SL unicast communications establishable between the first UE and the anchor UE. In such a mode, the target UE can evaluate the channel transmission quality between the first UE and each anchor UE, and thereby determine the SL positioning server UE. Compared with modes one and two, the signaling overhead is further reduced. By adopting the above-mentioned selection mode one according to the embodiments and introducing the above-mentioned three types of assistance information for selecting an SL positioning server UE, the target UE can be assisted in selecting an SL positioning server UE capable of establishing more unicast connections with anchor UEs, which is beneficial for the exchange of SL positioning assistance information and SL-PRS measurement data. In the case where the target UE determines the SL positioning server UE, the target UE transmits a notification message to at least one anchor UE, such that at least one anchor UE can become aware of the SL positioning server UE, thereby allowing procedures such as transmitting SL positioning assistance information and SL-PRS measurement to proceed.

### Selection Mode Two: Based on the SL Discovery Process

Exemplarily, mode two in the embodiments is implemented based on the model B discovery process.

FIG. 11 illustrates a schematic diagram of SL positioning according to some embodiments of the present disclosure. The method is applicable to a target UE, and the method includes at least one of the following processes.

In process 300, the target UE receives a ranging/SL positioning service request.

In some embodiments, the target UE receives the ranging/SL positioning service request from the SL positioning client UE.

In some embodiments, during the exposure of the ranging/SL positioning service over PC5, the SL positioning client UE is positioned over PC5. That is, the SL positioning client transmits the ranging/SL positioning service request to UE 1 over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of the target UE, the user information of the anchor UE, and the ranging/SL positioning QoS information.

In some embodiments, the target UE receives the ranging/SL positioning service request from the application layer.

In some embodiments, the ranging/SL positioning service request includes a result type and required QoS. The result type includes an absolute position, a relative position, or ranging information.

In process 310, the target UE transmits request messages to a plurality of second UEs.

In some embodiments, the second UE is one of candidate UEs.

In some embodiments, the candidate UEs are UEs that are candidates of the SL positioning server UE.

In some embodiments, the second UE is at least one of an anchor UE or another UE except the anchor UE and the target UE.

In some embodiments, the second UE is a UE that supports the SL positioning server UE function.

In some embodiments, the second UE is also referred to as at least one of an SL positioning service second UE, an SL positioning second UE, an SL service second UE, a positioning second UE, or a positioning service second UE.

In some embodiments, the request message is used to request the second UE to serve as an SL positioning server UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, the request message is further used to instruct the second UE to return at least one of the following pieces of information to the target UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, each RSRP between the second UE and the anchor UE is represented using n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the bit value corresponding to the information indicating whether an SL unicast communication is establishable between the second UE and the anchor UE is 0, indicating that SL unicast communication cannot be established between the second UE and the anchor UE. The bit value corresponding to the information indicating whether an SL unicast communication is establishable between the second UE and the anchor UE is 1, indicating that an SL unicast communication is establishable between the second UE and the anchor UE.

In some embodiments, the bit value corresponding to the information indicating whether an SL unicast communication is establishable between the second UE and the anchor UE is 0, indicating that an SL unicast communication is establishable between the second UE and the anchor UE. The bit value corresponding to the information indicating whether an SL unicast communication is establishable between the second UE and the anchor UE is 1, indicating that SL unicast communication cannot be established between the second UE and the anchor UE.

In some embodiments, the indication information is determined based on a comparison of magnitude between the RSRP information and RSRP threshold information.

In some embodiments, the request message further carries the RSRP threshold information.

In some embodiments, in a case where the RSRP between the second UE and the anchor UE is greater than the RSRP threshold, the requirement for establishing SL unicast communication is met, and an SL unicast communication is establishable between the second UE and the anchor UE. The indication information is used to indicate that an SL unicast communication is establishable between the second UE and the anchor UE.

In some embodiments, in a case where the RSRP between the second UE and the anchor UE is less than the RSRP threshold, the requirement for establishing SL unicast communication is not met, and SL unicast communication cannot be established between the second UE and the anchor UE. The indication information is used to indicate that SL unicast communication cannot be established between the second UE and the anchor UE.

In some embodiments, in the case where the RSRP between the second UE and the anchor UE is greater than the RSRP threshold, the bit value corresponding to the indication information is 1. In the case where the RSRP between the second UE and the anchor UE is less than the RSRP threshold, the bit value corresponding to the indication information is 0.

In some embodiments, in the case where the RSRP between the second UE and the anchor UE is greater than the RSRP threshold, the bit value corresponding to the indication information is 0. In the case where the RSRP between the second UE and the anchor UE is less than the RSRP threshold, the bit value corresponding to the indication information is 1.

In some embodiments, the number of SL unicast communications establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the number of SL unicast communications establishable between the second UE and the anchor UE is represented by a codepoint. The number of SL unicast communications establishable between the second UE and the anchor UE is in a one-to-one correspondence with the value of the codepoint.

In some embodiments, a binary value corresponding to three bits forms one codepoint, and each codepoint represents a quantity of SL unicast communications establishable between the second UE and the anchor UE. For example, 001 indicates that the number of SL unicast communications establishable between the second UE and the anchor UE is 1, and 010 indicates that the number of SL unicast communications establishable between the second UE and the anchor UE is 2.

In some embodiments, the corresponding relationship between the number of SL unicast communications establishable between the second UE and the anchor UE and the bit sequence and/or codepoint is determined through negotiation, stipulated by a protocol, or indicated by the target UE in the request message.

In some embodiments, the request message is further used to instruct the second UE to return at least one of the following pieces of information to the target UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is determined based on a comparison of magnitude between the RSRP information and RSRP threshold information.

In some embodiments, the request message further carries the RSRP threshold information.

In some embodiments, in a case where the RSRP between the second UE and the anchor UE in the UE list is greater than the RSRP threshold, the requirement for establishing SL unicast communication is met, and an SL unicast communication is establishable between the second UE and the anchor UE in the UE list. The indication information is used to indicate that an SL unicast communication is establishable between the second UE and the anchor UE in the UE list.

In some embodiments, in a case where the RSRP between the second UE and the anchor UE in the UE list is less than the RSRP threshold, the requirement for establishing SL unicast communication is not met, and SL unicast communication cannot be established between the second UE and the anchor UE in the UE list. The indication information is used to indicate that SL unicast communication cannot be established between the second UE and the anchor UE in the UE list.

In some embodiments, in the case where the RSRP between the second UE and the anchor UE in the UE list is greater than the RSRP threshold, the bit value corresponding to the indication information is 1. In the case where the RSRP between the second UE and the anchor UE in the UE list is less than the RSRP threshold, the bit value corresponding to the indication information is 0.

In some embodiments, in the case where the RSRP between the second UE and the anchor UE in the UE list is greater than the RSRP threshold, the bit value corresponding to the indication information is 0. In the case where the RSRP between the second UE and the anchor UE in the UE list is less than the RSRP threshold, the bit value corresponding to the indication information is 1.

In some embodiments, the number of SL unicast communications establishable between the second UE and the anchor UE in the UE list is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE in the UE list. The i^{th} anchor UE is one anchor UE among the anchor UEs in the UE list.

In some embodiments, the number of SL unicast communications establishable between the second UE and the anchor UE in the UE list is represented by a codepoint. The number of SL unicast communications establishable between the second UE and the anchor UE in the UE list is in a one-to-one correspondence with the value of the codepoint.

In some embodiments, a binary value corresponding to three bits forms a codepoint, and each codepoint represents a quantity of SL unicast communications establishable between the second UE and the anchor UE in the UE list. For example, 001 indicates that the number of SL unicast communications establishable between the second UE and the anchor UE in the UE list is 1, and 010 indicates that the number of SL unicast communications establishable between the second UE and the anchor UE in the UE list is 2.

In some embodiments, the corresponding relationship between the number of SL unicast communications establishable between the second UE and the anchor UE in the UE list and the bit sequence and/or codepoint is determined by negotiation, stipulated by a protocol, or indicated by the target UE in the request message.

In some embodiments, the indication information is indicated using at least one of numbers, letters, symbols, or bits.

In some embodiments, process 310 is performed during process 2, in which UE 1 discovers UE 2/ . . . /UE n.

In some embodiments, process 310 is performed after process 4, in which UE 1 and UE 2/ . . . /UE n perform capability exchange.

In process 320, the target UE receives response messages from the plurality of second UEs.

In some embodiments, the response message is used to indicate whether the second UE agrees to serve as an SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message is further used to carry at least one of the following pieces of information of the second UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the second UE is one of candidate UEs.

In some embodiments, the candidate UEs are UEs that are candidates of the SL positioning server UE.

In some embodiments, the response message is further used to carry at least one of the following pieces of information of the second UE:
RSRP information between the second UE and each anchor UE in the UE list;
information indicating whether an SL unicast communication is establishable between the second UE and the anchor UE in the UE list; or
the number of SL unicast communications establishable between the second UE and the anchor UE in the UE list.

The anchor UEs in the UE list are a subset of the anchor UEs.

In some embodiments, the UE list is a subset of a set formed by at least one anchor UE.

In some embodiments, process 320 is performed during process 2, in which UE 1 discovers UE 2/ . . . /UE n.

In some embodiments, process 320 is performed after process 4, in which UE 1 and UE 2/ . . . /UE n perform capability exchange.

In process 330, the target UE determines the SL positioning server UE.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the target UE calculates a mean RSRP of the second UE based on the RSRP information between the second UE and the anchor UE in the response information. The second UE with the largest mean RSRP is determined as the SL positioning server UE.

In some embodiments, the target UE determines the number of RSRPs greater than an RSRP threshold in the RSRP of the second UE based on the RSRP information between the second UE and the anchor UE in the response information. The second UE with the largest number of RSRPs greater than the RSRP threshold is determined as the SL positioning server UE.

In some embodiments, the target UE determines the number of anchor UEs capable of establishing an SL unicast communication with the second UE based on the information indicating whether an SL unicast communication is establishable between the second UE and the anchor UE in the response information. The second UE capable of establishing SL unicast communications with the largest number of anchor UEs is determined as the SL positioning server UE.

In some embodiments, the target UE determines the second UE capable of establishing SL unicast communications with the largest number of anchor UEs as the SL positioning server UE based on the number of SL unicast communications establishable between the second UE and the anchor UE in the response information.

In some embodiments, the SL positioning server UE is one of the following UEs:
a target UE;
an anchor UE; or
another UE other than the target UE and the anchor UE.

In some embodiments, the target UE determines the SL positioning server UE based on the response message.

In some embodiments, process 330 is performed during process 2, in which UE 1 discovers UE 2/ . . . /UE n.

In some embodiments, process 330 is performed after process 4, in which UE 1 and UE 2/ . . . /UE n perform capability exchange.

In process 340, the target UE transmits a confirmation message to the SL positioning server UE.

In some embodiments, the confirmation message is used to confirm that the receiver UE serves as the SL positioning server UE.

In some embodiments, the confirmation message is also referred to as at least one of an SL positioning server UE confirmation message, an SL positioning service confirmation message, an SL positioning UE confirmation message, an SL positioning confirmation message, a positioning server UE confirmation message, a positioning service confirmation message, or a positioning confirmation message.

In some embodiments, the confirmation message is also referred to as at least one of an SL positioning server UE role confirmation message, an SL positioning server role confirmation message, an SL positioning UE role confirmation message, an SL positioning role confirmation message, a positioning server UE role confirmation message, a positioning server role confirmation message, or a positioning role confirmation message.

In some embodiments, process 340 is performed during process 2, in which UE 1 discovers UE 2/ . . . /UE n.

In some embodiments, process 340 is performed after process 4, in which UE 1 and UE 2/ . . . /UE n perform capability exchange.

In process 350, the target UE transmits a notification message to the anchor UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message and/or request message to save signaling interaction.

In some embodiments, the notification message is carried in the metadata of the announcement message. For example, the role of the announcing UE is indicated as the target UE, and the SL positioning server UE role is not indicated; the identification information of the SL positioning server UE is carried in the metadata to save signaling interaction.

In some embodiments, the target UE may have different positioning service requests. To further distinguish the positioning session or ranging/SL positioning service request to which the SL positioning server UE belongs, the notification message further carries positioning session identification information.

In some embodiments, the notification message is carried in the SL positioning assistance information. The SL positioning assistance information is transmitted by broadcasting or multicasting. The target UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, process 350 is performed after process 2, in which UE 1 discovers UE 2/ . . . /UE n.

In some embodiments, process 350 is performed after process 4, in which UE 1 and UE 2/ . . . /UE n perform capability exchange.

In the embodiments, processes 310, 320, 330, 340, and 350 are optional. In different embodiments, one or more of the processes may be omitted or replaced, and processes 310, 320, 330, 340, and 350 may be performed in different orders or performed simultaneously. Processes 310 and 320 may be implemented as an independent embodiment; processes 330 and 340 may be implemented as an independent embodiment; processes 340 and 350 may be implemented as an independent embodiment; processes 310 to 330 may be implemented as an independent embodiment; processes 310, 320, and 340 may be implemented as an independent embodiment; processes 310, 320, and 350 may be implemented as an independent embodiment; processes 330, 340, and 350 may be implemented as an independent embodiment; processes 310, 320, 330, and 340 may be implemented as an independent embodiment; processes 310, 320, 330, and 350 may be implemented as an independent embodiment, which are not limited thereto.

Process 330 may be implemented as an independent embodiment, for example, independently implemented as a method for determining an SL positioning server UE or a method for determining information. Process 350 may be implemented as an independent embodiment, for example, independently implemented as a method for notifying an SL positioning server UE, a method for determining information, a method for transmitting information, or a method for transmitting a notification message. Processes 310 and 320 may be implemented as an independent embodiment, for example, independently implemented as a method for determining information or a method for transmitting a message. Processes 330 and 340 may be implemented as an independent embodiment, for example, independently implemented as a method for determining information or a method for determining an SL positioning server UE. Processes 340 and 350 may be implemented as an independent embodiment, for example, independently implemented as a method for notifying an SL positioning server UE, a method for determining information, a method for transmitting information, or a method for transmitting a notification message. Processes 310 to 330 may be implemented as an independent embodiment, for example, independently implemented as a method for determining information or a method for determining an SL positioning server UE. Processes 310, 320, and 340 may be implemented as an independent embodiment, for example, independently implemented as a method for confirming an SL positioning server UE or a method for transmitting information. Processes 310, 320, and 350 may be implemented as an independent embodiment, for example, independently implemented as a method for notifying an SL positioning server UE, a method for determining information, a method for transmitting information, or a method for transmitting a notification message. Processes 330, 340, and 350 may be implemented as an independent embodiment, for example, independently implemented as a method for determining information or a method for determining an SL positioning server UE. Processes 310, 320, 330, and 340 may be implemented as an independent embodiment, for example, independently implemented as a method for determining information or a method for determining an SL positioning server UE. Processes 310, 320, 330, and 350 may be implemented as an independent embodiment, for example, independently implemented as a method for notifying an SL positioning server UE, a method for determining information, a method for transmitting information, or a method for transmitting a notification message.

Based on the selection mode two according to the embodiments, the target UE may determine an SL positioning server UE based on at least one of the following modes.

In mode one, the target UE determines the SL positioning server UE based on the RSRP information between the second UE and the anchor UE. In such a mode, the target UE can acquire rich assistance information, such that the target UE can evaluate the channel transmission quality between the second UE and each anchor UE, and thus determine the SL positioning server UE.

In mode two, the target UE determines the SL positioning server UE based on the information indicating whether an SL unicast communication is establishable between the second UE and the anchor UE. In such a mode, the target UE can evaluate the channel transmission quality between the second UE and each anchor UE, and thereby determine the SL positioning server UE. Compared with mode one, the signaling overhead is greatly reduced.

In mode three, the target UE determines the SL positioning server UE based on the number of SL unicast communications establishable between the second UE and the anchor UE. In such a mode, the target UE can evaluate the channel transmission quality between the second UE and each anchor UE, and thereby determine the SL positioning server UE. Compared with modes one and two, the signaling overhead is further reduced.

By adopting selection mode two in the embodiments and introducing the above-mentioned three types of assistance information for selecting an SL positioning server UE, the target UE can be assisted in selecting the SL positioning server UE, which is beneficial for interacting SL positioning assistance information and SL-PRS measurement data. In the case where the target UE determines the SL positioning server UE, the target UE transmits a notification message to at least one anchor UE, such that at least one anchor UE can become aware of the SL positioning server UE, thereby allowing procedures such as transmitting SL positioning assistance information and SL-PRS measurement to proceed.

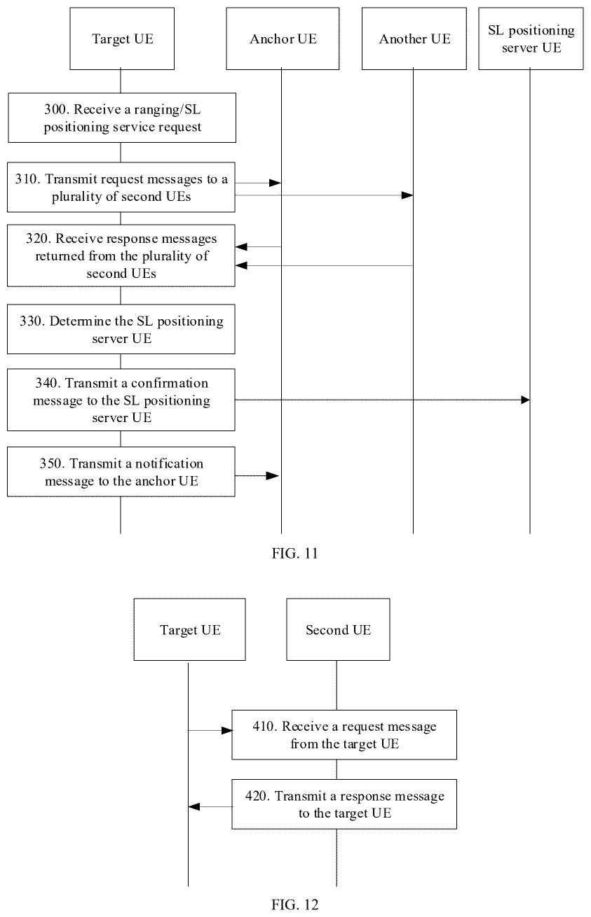

FIG. 12 illustrates a schematic diagram of a communication method applicable to an SL positioning service scenario according to some embodiments of the present disclosure. The method is applicable to a second UE. The method includes at least one of the following processes.

In process 410, the second UE receives a request message from the target UE.

In some embodiments, the second UE is one of candidate UEs.

In some embodiments, the candidate UEs are UEs that are candidates of the SL positioning server UE.

In some embodiments, the second UE is at least one of an anchor UE or another UE except the anchor UE and the target UE.

In some embodiments, the second UE is a UE that supports the SL positioning server UE function.

In some embodiments, the second UE is also referred to as at least one of an SL positioning service second UE, an SL positioning second UE, an SL service second UE, a positioning second UE, or a positioning service second UE.

In some embodiments, the request message is used to request the second UE to serve as an SL positioning server UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, the request message is further used to instruct the second UE to return at least one of the following pieces of information to the target UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the request message further includes a capability request message.

In some embodiments, during the capability exchange process, the second UE receives the capability request message from the target UE.

In some embodiments, the capability exchange process is also referred to as at least one of an exchange process, a capability interaction process, an SL positioning capability exchange process, or an SL positioning capability interaction process.

In some embodiments, the capability request message is also referred to as at least one of a request message, an exchange request message, an interaction request message, a capability exchange request message, a capability interaction request message, an SL positioning capability request message, an SL positioning capability exchange request message, or an SL positioning capability interaction request message.

In some embodiments, the capability request message is further used to instruct the second UE to return at least one of the following pieces of information to the target UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, each RSRP between the second UE and the anchor UE is represented using n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the bit value corresponding to the information indicating whether an SL unicast communication is establishable between the second UE and the anchor UE is 0, indicating that SL unicast communication cannot be established between the second UE and the anchor UE. The bit value corresponding to the information indicating whether an SL unicast communication is establishable between the second UE and the anchor UE is 1, indicating that an SL unicast communication is establishable between the second UE and the anchor UE.

In some embodiments, the bit value corresponding to the information indicating whether an SL unicast communication is establishable between the second UE and the anchor UE is 0, indicating that an SL unicast communication is establishable between the second UE and the anchor UE. The bit value corresponding to the information indicating whether an SL unicast communication is establishable between the second UE and the anchor UE is 1, indicating that SL unicast communication cannot be established between the second UE and the anchor UE.

In some embodiments, the indication information is determined based on a comparison of magnitude between the RSRP information and RSRP threshold information.

In some embodiments, the request message further carries the RSRP threshold information.

In some embodiments, the capability request message further carries the RSRP threshold information.

In some embodiments, in a case where the RSRP between the second UE and the anchor UE is greater than the RSRP threshold, the requirement for establishing SL unicast communication is met, and an SL unicast communication is establishable between the second UE and the anchor UE. The indication information is used to indicate that an SL unicast communication is establishable between the second UE and the anchor UE.

In some embodiments, in a case where the RSRP between the second UE and the anchor UE is less than the RSRP threshold, the requirement for establishing SL unicast communication is not met, and SL unicast communication cannot be established between the second UE and the anchor UE. The indication information is used to indicate that SL unicast communication cannot be established between the second UE and the anchor UE.

In some embodiments, in the case where the RSRP between the second UE and the anchor UE is greater than the RSRP threshold, the bit value corresponding to the indication information is 1. In the case where the RSRP between the second UE and the anchor UE is less than the RSRP threshold, the bit value corresponding to the indication information is 0.

In some embodiments, in the case where the RSRP between the second UE and the anchor UE is greater than the RSRP threshold, the bit value corresponding to the indication information is 0. In the case where the RSRP between the second UE and the anchor UE is less than the RSRP threshold, the bit value corresponding to the indication information is 1.

In some embodiments, the number of SL unicast communications establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the number of SL unicast communications establishable between the second UE and the anchor UE is represented by a codepoint. The number of SL unicast communications establishable between the second UE and the anchor UE is in a one-to-one correspondence with the value of the codepoint.

In some embodiments, a binary value corresponding to three bits forms one codepoint, and each codepoint represents a quantity of SL unicast communications establishable between the second UE and the anchor UE. For example, 001 indicates that the number of SL unicast communications establishable between the second UE and the anchor UE is 1, and 010 indicates that the number of SL unicast communications establishable between the second UE and the anchor UE is 2.

In some embodiments, the corresponding relationship between the number of SL unicast communications establishable between the second UE and the anchor UE and the bit sequence and/or codepoint is determined through negotiation, stipulated by a protocol, or indicated by the target UE in the request message.

In some embodiments, the request message is further used to instruct the second UE to return at least one of the following pieces of information to the target UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, the capability request message is further used to instruct the second UE to return at least one of the following pieces of information to the target UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is determined based on a comparison of magnitude between the RSRP information and RSRP threshold information.

In some embodiments, the request message further carries the RSRP threshold information.

In some embodiments, in a case where the RSRP between the second UE and the anchor UE in the UE list is greater than the RSRP threshold, the requirement for establishing SL unicast communication is met, and an SL unicast communication is establishable between the second UE and the anchor UE in the UE list. The indication information is used to indicate that an SL unicast communication is establishable between the second UE and the anchor UE in the UE list.

In some embodiments, in a case where the RSRP between the second UE and the anchor UE in the UE list is less than the RSRP threshold, the requirement for establishing SL unicast communication is not met, and SL unicast communication cannot be established between the second UE and the anchor UE in the UE list. The indication information is used to indicate that SL unicast communication cannot be established between the second UE and the anchor UE in the UE list.

In some embodiments, in the case where the RSRP between the second UE and the anchor UE in the UE list is greater than the RSRP threshold, the bit value corresponding to the indication information is 1. In the case where the RSRP between the second UE and the anchor UE in the UE list is less than the RSRP threshold, the bit value corresponding to the indication information is 0.

In some embodiments, in the case where the RSRP between the second UE and the anchor UE in the UE list is greater than the RSRP threshold, the bit value corresponding to the indication information is 0. In the case where the RSRP between the second UE and the anchor UE in the UE list is less than the RSRP threshold, the bit value corresponding to the indication information is 1.

In some embodiments, the number of SL unicast communications establishable between the second UE and the anchor UE in the UE list is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE in the UE list. The i^{th} anchor UE is one anchor UE among the anchor UEs in the UE list.

In some embodiments, the number of SL unicast communications establishable between the second UE and the anchor UE in the UE list is represented by a codepoint. The number of SL unicast communications establishable between the second UE and the anchor UE in the UE list is in a one-to-one correspondence with the value of the codepoint.

In some embodiments, a binary value corresponding to three bits forms a codepoint, and each codepoint represents a quantity of SL unicast communications establishable between the second UE and the anchor UE in the UE list. For example, 001 indicates that the number of SL unicast communications establishable between the second UE and the anchor UE in the UE list is 1, and 010 indicates that the number of SL unicast communications establishable between the second UE and the anchor UE in the UE list is 2.

In some embodiments, the corresponding relationship between the number of SL unicast communications establishable between the second UE and the anchor UE in the UE list and the bit sequence and/or codepoint is determined by negotiation, stipulated by a protocol, or indicated by the target UE in the request message.

In some embodiments, the indication information is indicated using at least one of numbers, letters, symbols, or bits.

In some embodiments, process 410 is performed during process 2, in which UE 1 discovers UE 2/ . . . /UE n.

In some embodiments, process 410 is performed after process 4, in which UE 1 and UE 2/ . . . /UE n perform capability exchange.

In process 420, the second UE transmits a response message to the target UE.

In some embodiments, the response message carries information for the target UE to determine the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message is further used to carry at least one of the following pieces of information of the second UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the response message is further used to carry at least one of the following pieces of information of the second UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, the response message further includes a capability response message.

In some embodiments, during the capability exchange process, the second UE returns a capability response message to the target UE.

In some embodiments, the capability exchange process is also referred to as at least one of an exchange process, a capability interaction process, an SL positioning capability exchange process, or an SL positioning capability interaction process.

In some embodiments, the capability response message is also referred to as at least one of a response message, an exchange response message, an interaction response message, a capability exchange response message, or a capability interaction response message.

In some embodiments, the capability response message is further used to carry at least one of the following pieces of information of the second UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the capability response message is further used to carry at least one of the following pieces of information of the second UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, process 420 is performed during process 2, in which UE 1 discovers UE 2/ . . . /UE n.

In some embodiments, process 420 is performed after process 4, in which UE 1 and UE 2/ . . . /UE n perform capability exchange.

In the embodiments, processes 410 and 420 are optional. In different embodiments, one or more of the processes may be omitted or replaced, and processes 410 and 420 may be performed in different orders or performed simultaneously. Processes 410 and 420 may be implemented as an independent embodiment, for example, independently implemented as a method for transmitting information or a method for transmitting a message, which are not limited thereto.

By adopting the method according to the embodiments, the second UE can receive the request message from the target UE, and the second UE can return response information to the target UE, thus helping the target UE to select an SL positioning server UE that supports the SL positioning server UE function, which is beneficial for interacting SL positioning assistance information and SL-PRS measurement data.

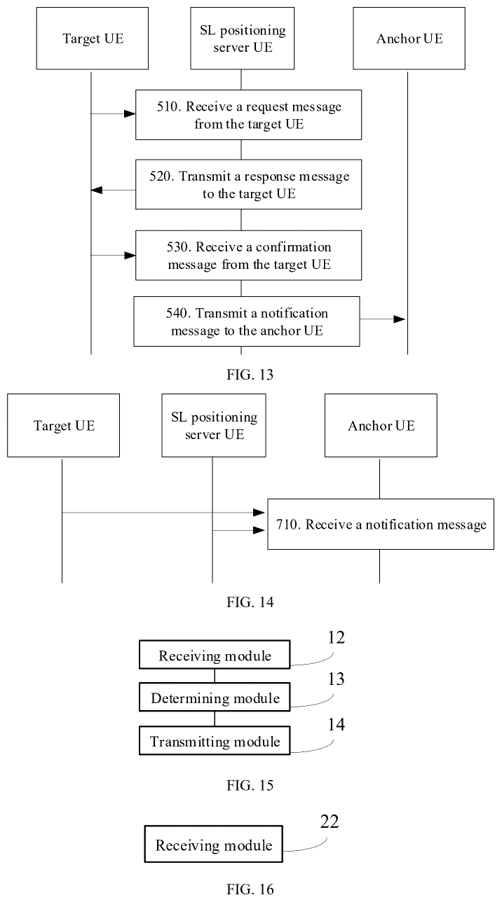

FIG. 13 illustrates a schematic diagram of a communication method applicable to an SL positioning service scenario according to some embodiments of the present disclosure. The method is applicable to an SL positioning server UE. The method includes at least one of the following processes.

In process 510, the SL positioning server UE receives a request message from the target UE.

In some embodiments, the request message is used to request a receiver UE to serve as the SL positioning server UE.

In some embodiments, the receiver UE is also referred to as at least one of an SL positioning service receiver UE, an SL positioning receiver UE, an SL service receiver UE, a positioning receiver UE, or a positioning service receiver UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, process 510 is performed during process 2, in which UE 1 discovers UE 2/ . . . /UE n.

In some embodiments, process 510 is performed after process 4, in which UE 1 and UE 2/ . . . /UE n perform capability exchange.

In process 520, the SL positioning server UE transmits a response message to the target UE.

In some embodiments, the response message is used to indicate whether the receiver UE agrees to serve as the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message includes a first bit, wherein a bit value of the first bit is used to indicate whether the receiver UE agrees to serve as the SL positioning server UE. The first bit is one of the bits corresponding to the response message.

In some embodiments, the bit value corresponding to the first bit being 0 indicates that the receiver UE does not agree to serve as the SL positioning server UE. The bit value corresponding to the first bit being 1 indicates that the receiver UE agrees to serve as the SL positioning server UE.

In some embodiments, the bit value corresponding to the first bit being 1 indicates that the receiver UE does not agree to serve as the SL positioning server UE. The bit value corresponding to the first bit being 0 indicates that the receiver UE agrees to serve as the SL positioning server UE.

In some embodiments, in the case where the response message indicates that the receiver UE does not agree to serve as the SL positioning server UE, the target UE re-determines the SL positioning server UE.

In some embodiments, in a case where the target UE does not receive a response message, the target UE re-determines the SL positioning server UE.

In some embodiments, process 520 is performed during process 2, in which UE 1 discovers UE 2/ . . . /UE n.

In some embodiments, process 520 is performed after process 4, in which UE 1 and UE 2/ . . . /UE n perform capability exchange.

In process 530, the SL positioning server UE receives a confirmation message from the target UE.

In some embodiments, the confirmation message is used to confirm that the receiver UE serves as the SL positioning server UE.

In some embodiments, the confirmation message is also referred to as at least one of an SL positioning server UE confirmation message, an SL positioning service confirmation message, an SL positioning UE confirmation message, an SL positioning confirmation message, a positioning server UE confirmation message, a positioning service confirmation message, or a positioning confirmation message.

In some embodiments, the confirmation message is also referred to as at least one of an SL positioning server UE role confirmation message, an SL positioning server role confirmation message, an SL positioning UE role confirmation message, an SL positioning role confirmation message, a positioning server UE role confirmation message, a positioning server role confirmation message, or a positioning role confirmation message.

In some embodiments, process 530 is performed during process 2, in which UE 1 discovers UE 2/ . . . /UE n.

In some embodiments, process 530 is performed after process 4, in which UE 1 and UE 2/ . . . /UE n perform capability exchange.

In process 540, the SL positioning server UE transmits a notification message to at least one anchor UE.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the SL positioning server UE is one of the following UEs:
a target UE;
an anchor UE; or
another UE other than the target UE and the anchor UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message does not carry the identification information of the SL positioning server UE.

In some embodiments, the notification message is further used to indicate that the SL positioning server UE is a local UE.

In some embodiments, in a case where no identification information of the SL positioning server UE is present in the notification message, it is understood that the SL positioning server UE is indicated as the local UE.

In some embodiments, in a case where the identification information of the SL positioning server UE in the notification message is a special ID, it is understood that the SL positioning server UE is indicated as the local UE.

In some embodiments, the notification message carries bit indication information; and a bit value of the bit indication information being 1 or true indicates that the SL positioning server UE is indicated as the local UE.

In the above cases, the identification information of the SL positioning server UE may not be carried in the notification message, thereby saving signaling overhead.

In some embodiments, the notification message carries bit indication information; in a case where the bit value of the bit indication information is 0 or false, or in a case where the notification message does not carry the bit indication information, the notification message needs to carry complete identification information of the SL positioning server UE.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message and/or request message to save signaling interaction.

In some embodiments, the role of an announcing UE includes a target UE, an SL positioning server UE, an anchor UE, and an anchor UE capable of acquiring its own position. The role of the announcing UE being the SL positioning server UE means that the announcing UE can implement the function of an SL positioning server UE. However, it has not been determined who is the SL positioning server UE for a certain SL positioning service request.

In some embodiments, the notification message is carried in the metadata of the announcement message, and by introducing a new UE role, such as “authorized server UE” or “confirmed server UE”, the UE is implicitly indicated as the SL positioning server UE, so as to save signaling interaction.

In some embodiments, the notification message is carried in the SL positioning assistance information. The SL positioning assistance information is transmitted by broadcasting or multicasting. The SL positioning server UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, process 540 is performed after process 2, in which UE 1 discovers UE 2/ . . . /UE n.

In some embodiments, process 540 is performed after process 4, in which UE 1 and UE 2/ . . . /UE n perform capability exchange.

In the embodiments, processes 510, 520, 530, and 540 are optional. In different embodiments, one or more of the processes may be omitted or replaced, and processes 510, 520, 530, and 540 may be performed in different orders or performed simultaneously. Process 530 may be implemented as an independent embodiment; process 540 may be implemented as an independent embodiment; processes 510 and 520 may be implemented as an independent embodiment; processes 530 and 540 may be implemented as an independent embodiment; processes 510, 520, and 530 may be implemented as an independent embodiment; processes 510, 520, and 540 may be implemented as an independent embodiment, which are not limited thereto.

Process 530 may be implemented as an independent embodiment, for example, independently implemented as a method for receiving a message or a method for confirming information. Process 540 may be implemented as an independent embodiment, for example, independently implemented as a method for notifying an SL positioning server UE, a method for transmitting a notification message, or a method for transmitting information. Processes 510 and 520 may be implemented as an independent embodiment, for example, independently implemented as a method for receiving a message, a method for transmitting a message, or a method for transmitting information. Processes 530 and 540 may be implemented as an independent embodiment, for example, independently implemented as a method for notifying an SL positioning server UE, a method for determining information, a method for transmitting information, or a method for transmitting a notification message. Processes 510, 520, and 530 may be implemented as an independent embodiment, for example, independently implemented as a method for receiving a message or a method for confirming information. Processes 510, 520, and 540 may be implemented as an independent embodiment, for example, independently implemented as a method for notifying an SL positioning server UE, a method for determining information, a method for transmitting information, or a method for transmitting a notification message.

By adopting the method according to the embodiments, the SL positioning server UE can receive a confirmation message from the target UE, confirming itself as the SL positioning server UE. The target UE is helped to select an SL positioning server UE that supports the SL positioning server UE function, which is beneficial for interacting SL positioning assistance information and SL-PRS measurement data. In the case where the target UE determines the SL positioning server UE, the SL positioning server UE may also transmit a notification message to at least one anchor UE, such that at least one anchor UE can become aware of the SL positioning server UE, thereby allowing procedures such as transmitting SL positioning assistance information and SL-PRS measurement to proceed.

FIG. 14 illustrates a schematic diagram of a communication method applicable to an SL positioning service scenario according to some embodiments of the present disclosure. The method is applicable to an anchor UE and includes the following processes.

In process 710, the anchor UE receives a notification message.

In some embodiments, the anchor UE receives a notification message from the target UE.

In some embodiments, the anchor UE receives a notification message from the SL positioning server UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message does not carry the identification information of the SL positioning server UE.

In some embodiments, the notification message is further used to indicate that the SL positioning server UE is a local UE.

In some embodiments, in a case where no identification information of the SL positioning server UE is present in the notification message, it is understood that the SL positioning server UE is indicated as the local UE.

In some embodiments, in a case where the identification information of the SL positioning server UE in the notification message is a special ID, it is understood that the SL positioning server UE is indicated as the local UE.

In some embodiments, the notification message carries bit indication information; and a bit value of the bit indication information being 1 or true indicates that the SL positioning server UE is indicated as the local UE.

In the above cases, the identification information of the SL positioning server UE may not be carried in the notification message, thereby saving signaling overhead.

In some embodiments, the notification message carries bit indication information; in a case where the bit value of the bit indication information is 0 or false, or in a case where the notification message does not carry the bit indication information, the notification message needs to carry complete identification information of the SL positioning server UE.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the role of an announcing UE includes a target UE, an SL positioning server UE, an anchor UE, and an anchor UE capable of acquiring its own position. The role of the announcing UE being the SL positioning server UE means that the announcing UE can implement the function of an SL positioning server UE. However, it has not been determined who is the SL positioning server UE for a certain SL positioning service request.

In some embodiments, the notification message is carried in the metadata of the announcement message, and by introducing a new UE role, such as “authorized server UE” or “confirmed server UE”, the UE is implicitly indicated as the SL positioning server UE, so as to save signaling interaction.

In some embodiments, the notification message is carried in the SL positioning assistance information. The SL positioning assistance information is transmitted by broadcasting or multicasting. The SL positioning server UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the SL positioning server UE is one of the following UEs:
a target UE;
an anchor UE; or
another UE other than the target UE and the anchor UE.

In some embodiments, process 710 is performed after process 2, in which UE 1 discovers UE 2/ . . . /UE n.

In some embodiments, process 710 is performed after process 4, in which UE 1 and UE 2/ . . . /UE n perform capability exchange.

In the embodiments, process 710 is optional. In different embodiments, one or more of the processes may be omitted or replaced. Process 710 may be implemented as an independent embodiment, for example, independently implemented as a method for notifying information, a method for transmitting a notification message, or a method for notifying an SL positioning server UE, which are not limited thereto.

By adopting the method according to the embodiments, the anchor UE receives a notification message from the SL positioning server UE, or the anchor UE receives a notification message from the target UE, such that the anchor UE can become aware of the SL positioning server UE, thereby allowing procedures such as transmitting SL positioning assistance information and SL-PRS measurement to proceed.

FIG. 15 illustrates a structural block diagram of a communication apparatus applicable to an SL positioning service scenario according to some embodiments of the present disclosure. The apparatus may be implemented as all or part of a target UE in the SL positioning service scenario. The apparatus includes:
a receiving module 12, configured to receive a ranging/SL positioning service request; and
a determining module 13, configured to determine an SL positioning server UE.

The SL positioning server UE is a UE configured to implement an SL positioning service function.

In some embodiments, the target UE receives the ranging/SL positioning service request from the SL positioning client UE.

In some embodiments, during the exposure of the ranging/SL positioning service over PC5, the SL positioning client UE is positioned over PC5. That is, the SL positioning client transmits a ranging/SL positioning service request to the target UE over the PC5 interface.

In some embodiments, for absolute positioning, the ranging/SL positioning service request includes user information of the SL positioning client UE and user information of a target UE, as well as required positioning QoS.

In some embodiments, for relative position or ranging information, the ranging/SL positioning service request includes the user information of the SL positioning client UE, the user information of the target UE, the user information of the anchor UE, and the ranging/SL positioning QoS information.

In some embodiments, the target UE receives the ranging/SL positioning service request from the application layer.

In some embodiments, the ranging/SL positioning service request includes a result type and required QoS. The result type includes an absolute position, a relative position, or ranging information.

In some embodiments, the target UE determines the SL positioning server UE based on at least one of the following pieces of information:
RSRP information between a first UE and at least one anchor UE;
information indicating whether an SL unicast communication is establishable between the first UE and the at least one anchor UE; or
the number of SL unicast communications establishable between the first UE and the at least one anchor UE.

The first UE is one of a plurality of UEs, wherein the plurality of UEs are UEs performing capability exchange with the target UE.

In some embodiments, the target UE determines the SL positioning server UE based on at least one of the following pieces of information:
RSRP information between a first UE and each anchor UE in a UE list;
information indicating whether an SL unicast communication is establishable between the first UE and each anchor UE in the UE list; or
the number of SL unicast communications establishable between the first UE and all anchor UEs in the UE list.

The first UE is one of a plurality of UEs, wherein the plurality of UEs are UEs performing capability exchange with the target UE. The UE list is a subset of a set formed by at least one anchor UE.

In some embodiments, the target UE determines the SL positioning server UE based on at least one of the following pieces of information:
RSRP information between a second UE and at least one anchor UE;
information indicating whether an SL unicast communication is establishable between the second UE and the at least one anchor UE; or
the number of SL unicast communications establishable between the second UE and the at least one anchor UE.

The second UE is one of candidate UEs, wherein the candidate UEs are UEs that are candidates of the SL positioning server UE.

In some embodiments, the target UE determines the SL positioning server UE based on at least one of the following pieces of information:
RSRP information between a second UE and each anchor UE in a UE list;
information indicating whether an SL unicast communication is establishable between the second UE and each anchor UE in the UE list; or
the number of SL unicast communications establishable between the second UE and all anchor UEs in the UE list.

The second UE is one of candidate UEs, wherein the candidate UEs are UEs that are candidates of the SL positioning server UE. The UE list is a subset of a set formed by at least one anchor UE.

In some embodiments, the apparatus further includes a transmitting module 14.

The transmitting module 14 is configured to transmit a request message to the SL positioning server UE.

The receiving module 12 is configured to receive a response message from the SL positioning server UE.

The request message is used to request a receiver UE to serve as the SL positioning server UE, and the response message is used to indicate whether the receiver UE agrees to serve as the SL positioning server UE.

In some embodiments, in a case where the response message indicates that the receiver UE does not agree to serve as the SL positioning server UE, the determining module 13 is configured to re-determine the SL positioning server UE.

In some embodiments, in a case where the response message is not received, the determining module 13 is configured to re-determine the SL positioning server UE.

In some embodiments, the transmitting module 14 is configured to transmit capability request messages to the plurality of UEs; the receiving module 12 is configured for the target UE to receive capability response messages from the plurality of UEs; and the determining module 13 is configured to determine the SL positioning server UE based on the capability response messages.

In some embodiments, during the capability exchange process, the target UE transmits the capability request messages to a plurality of UEs.

In some embodiments, the capability exchange process is also referred to as at least one of an exchange process, a capability interaction process, an SL positioning capability exchange process, or an SL positioning capability interaction process.

In some embodiments, the capability request message is also referred to as at least one of a request message, an exchange request message, an interaction request message, a capability exchange request message, a capability interaction request message, an SL positioning capability request message, an SL positioning capability exchange request message, or an SL positioning capability interaction request message.

In some embodiments, the plurality of UEs include the anchor UE and/or other UEs except the anchor UE and the target UE.

In some embodiments, the first UE is one UE among a plurality of UEs, wherein the plurality of UEs are UEs performing capability exchange with the target UE.

In some embodiments, the capability request message is further used to instruct the first UE among the plurality of UEs to return at least one of the following pieces of information to the target UE:
RSRP information between the first UE and at least one anchor UE;
information indicating whether an SL unicast communication is establishable between the first UE and the at least one anchor UE; or
the number of SL unicast communications establishable between the first UE and the at least one anchor UE.

In some embodiments, each RSRP between the first UE and the anchor UE is represented by n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the first UE and the anchor UE is represented by a bit sequence (bitmap). Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE. The i^{th} anchor UE is one anchor UE among the anchor UEs.

In some embodiments, the bit value corresponding to the information indicating whether an SL unicast communication is establishable between the first UE and the anchor UE is 0, indicating that SL unicast communication cannot be established between the first UE and the anchor UE. The bit value corresponding to the information indicating whether an SL unicast communication is establishable between the first UE and the anchor UE is 1, indicating that an SL unicast communication is establishable between the first UE and the anchor UE.

In some embodiments, the bit value corresponding to the information indicating whether an SL unicast communication is establishable between the first UE and the anchor UE is 0, indicating that an SL unicast communication is establishable between the first UE and the anchor UE. The bit value corresponding to the information indicating whether an SL unicast communication is establishable between the first UE and the anchor UE is 1, indicating that SL unicast communication cannot be established between the first UE and the anchor UE.

In some embodiments, the indication information is determined based on a comparison of magnitude between the RSRP information and RSRP threshold information.

In some embodiments, the capability request message further carries the RSRP threshold information.

In some embodiments, in a case where the RSRP between the first UE and the anchor UE is greater than the RSRP threshold, the requirement for establishing SL unicast communication is met, and an SL unicast communication is establishable between the first UE and the anchor UE. The indication information is used to indicate that an SL unicast communication is establishable between the first UE and the anchor UE.

In some embodiments, in a case where the RSRP between the first UE and the anchor UE is less than the RSRP threshold, the requirement for establishing SL unicast communication is not met, and SL unicast communication cannot be established between the first UE and the anchor UE. The indication information is used to indicate that SL unicast communication cannot be established between the first UE and the anchor UE.

In some embodiments, in the case where the RSRP between the first UE and the anchor UE is greater than the RSRP threshold, the bit value corresponding to the indication information is 1. In the case where the RSRP between the first UE and the anchor UE is less than the RSRP threshold, the bit value corresponding to the indication information is 0.

In some embodiments, in the case where the RSRP between the first UE and the anchor UE is greater than the RSRP threshold, the bit value corresponding to the indication information is 0. In the case where the RSRP between the first UE and the anchor UE is less than the RSRP threshold, the bit value corresponding to the indication information is 1.

In some embodiments, the number of SL unicast communications establishable between the first UE and the anchor UE is represented by a bit sequence. Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE. The i^{th} anchor UE is one anchor UE among the anchor UEs.

In some embodiments, the number of SL unicast communications establishable between the first UE and the anchor UE is represented by a codepoint. The number of SL unicast communications establishable between the first UE and the anchor UE is in a one-to-one correspondence with the value of the codepoint.

In some embodiments, a binary value corresponding to three bits forms one codepoint, and each codepoint represents a quantity of SL unicast communications establishable between the first UE and the anchor UE. For example, 001 indicates that the number of SL unicast communications establishable between the first UE and the anchor UE is 1, and 010 indicates that the number of SL unicast communications establishable between the first UE and the anchor UE is 2.

In some embodiments, the corresponding relationship between the number of SL unicast communications establishable between the first UE and the anchor UE and the bit sequence and/or codepoint is determined through negotiation, stipulated by a protocol, or indicated by the target UE in the capability request message.

In some embodiments, the capability request message is further used to instruct the first UE among the plurality of UEs to return at least one of the following pieces of information to the target UE:
RSRP information between the first UE and each anchor UE in a UE list;
information indicating whether an SL unicast communication is establishable between the first UE and each anchor UE in the UE list; or
the number of SL unicast communications establishable between the first UE and all anchor UEs in the UE list;
The anchor UEs in the UE list are a subset of the anchor UEs.

In some embodiments, the UE list is a subset of a set formed by at least one anchor UE.

In some embodiments, the indication information is determined based on a comparison of magnitude between the RSRP information and RSRP threshold information.

In some embodiments, the capability request message further carries the RSRP threshold information.

In some embodiments, in a case where the RSRP between the first UE and the anchor UE in the UE list is greater than the RSRP threshold, the requirement for establishing SL unicast communication is met, and an SL unicast communication is establishable between the first UE and the anchor UE in the UE list. The indication information is used to indicate that an SL unicast communication is establishable between the first UE and the anchor UE in the UE list.

In some embodiments, in a case where the RSRP between the first UE and the anchor UE in the UE list is less than the RSRP threshold, the requirement for establishing SL unicast communication is not met, and SL unicast communication cannot be established between the first UE and the anchor UE in the UE list. The indication information is used to indicate that SL unicast communication cannot be established between the first UE and the anchor UE in the UE list.

In some embodiments, in the case where the RSRP between the first UE and the anchor UE in the UE list is greater than the RSRP threshold, the bit value corresponding to the indication information is 1. In the case where the RSRP between the first UE and the anchor UE in the UE list is less than the RSRP threshold, the bit value corresponding to the indication information is 0.

In some embodiments, in the case where the RSRP between the first UE and the anchor UE in the UE list is greater than the RSRP threshold, the bit value corresponding to the indication information is 0. In the case where the RSRP between the first UE and the anchor UE in the UE list is less than the RSRP threshold, the bit value corresponding to the indication information is 1.

In some embodiments, the number of SL unicast communications establishable between the first UE and the anchor UE in the UE list is represented by a bit sequence. Each bit in the bit sequence is used to indicate whether an SL unicast communication is establishable between the first UE and each anchor UE.

In some embodiments, the i^{th} bit in the bit sequence indicates that an SL unicast communication is establishable between the first UE and the i^{th} anchor UE in the UE list. The i^{th} anchor UE is one anchor UE among the anchor UEs in the UE list.

In some embodiments, the number of SL unicast communications establishable between the first UE and the anchor UE in the UE list is represented by a codepoint. The number of SL unicast communications establishable between the first UE and the anchor UE in the UE list is in a one-to-one correspondence with the value of the codepoint.

In some embodiments, a binary value corresponding to three bits forms a codepoint, and each codepoint represents a quantity of SL unicast communications establishable between the first UE and the anchor UE in the UE list. For example, 001 indicates that the number of SL unicast communications establishable between the first UE and the anchor UE in the UE list is 1, and 010 indicates that the number of SL unicast communications establishable between the first UE and the anchor UE in the UE list is 2.

In some embodiments, the corresponding relationship between the number of SL unicast communications establishable between the first UE and the anchor UE in the UE list and the bit sequence and/or codepoint is determined by negotiation, stipulated by a protocol, or indicated by the target UE in the capability request message.

In some embodiments, the first UE among the plurality of UEs includes a UE among the anchor UEs, and/or a UE among other UEs except the anchor UE and the target UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is indicated using at least one of numbers, letters, symbols, or bits.

In some embodiments, during the capability exchange process, the target UE receives the capability response messages from the plurality of UEs.

In some embodiments, the capability exchange process is also referred to as at least one of an exchange process, a capability interaction process, an SL positioning capability exchange process, or an SL positioning capability interaction process.

In some embodiments, the capability response message is also referred to as at least one of a response message, an exchange response message, an interaction response message, a capability exchange response message, or a capability interaction response message.

In some embodiments, the plurality of UEs include the anchor UE and/or other UEs except the anchor UE and the target UE.

In some embodiments, the capability response message is further used to carry at least one of the following pieces of information of the first UE among the plurality of UEs:
RSRP information between the first UE and the at least one anchor UE;
information indicating whether an SL unicast communication is establishable between the first UE and the at least one anchor UE; or
the number of SL unicast communications establishable between the first UE and the at least one anchor UE.

In some embodiments, the capability response message is further used to carry at least one of the following pieces of information of the first UE among the plurality of UEs:
RSRP information between the first UE and each anchor UE in the UE list;
information indicating whether an SL unicast communication is establishable between the first UE and each anchor UE in the UE list; or
the number of SL unicast communications establishable between the first UE and all anchor UEs in the UE list;
wherein the anchor UEs in the UE list are a subset of the anchor UEs.

In some embodiments, the UE list is a subset of a set formed by at least one anchor UE.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the target UE calculates a mean RSRP of the first UE based on the RSRP information between the first UE and the anchor UE in the capability response information. The first UE with the largest mean RSRP is determined as the SL positioning server UE.

In some embodiments, the target UE determines the number of RSRPs greater than an RSRP threshold in the RSRP of the first UE based on the RSRP information between the first UE and the anchor UE in the capability response information. The first UE with the largest number of RSRPs greater than the RSRP threshold is determined as the SL positioning server UE.

In some embodiments, the target UE determines the number of anchor UEs capable of establishing an SL unicast communication with the first UE based on the information indicating whether an SL unicast communication is establishable between the first UE and the anchor UE in the capability response information. The first UE capable of establishing SL unicast communications with the largest number of anchor UEs is determined as the SL positioning server UE.

In some embodiments, the target UE determines the first UE capable of establishing SL unicast communications with the largest number of anchor UEs as the SL positioning server UE based on the number of SL unicast communications establishable between the first UE and the anchor UE in the response capability information.

In some embodiments, the SL positioning server UE is one of the following UEs:
a target UE;
an anchor UE; or
another UE other than the target UE and the anchor UE.

In some embodiments, the transmitting module 14 is configured to transmit request messages to a plurality of second UEs. The receiving module 12 is configured to receive response messages from the plurality of second UEs. The request messages are used to request the second UEs to serve as the SL positioning server UE, and the response messages are used to indicate whether the second UEs agree to serve as the SL positioning server UE.

In some embodiments, the second UE is one of candidate UEs.

In some embodiments, the candidate UEs are UEs that are candidates of the SL positioning server UE.

In some embodiments, the second UE is at least one of an anchor UE or another UE except the anchor UE and the target UE.

In some embodiments, the second UE is a UE that supports the SL positioning server UE function.

In some embodiments, the second UE is also referred to as at least one of an SL positioning service second UE, an SL positioning second UE, an SL service second UE, a positioning second UE, or a positioning service second UE.

In some embodiments, the request message is used to request the second UE to serve as an SL positioning server UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, the request message is further used to instruct the second UE to return at least one of the following pieces of information to the target UE:
RSRP information between the second UE and the at least one anchor UE;
information indicating whether an SL unicast communication is establishable between the second UE and the at least one anchor UE; or
the number of SL unicast communications establishable between the second UE and the at least one anchor UE.

In some embodiments, each RSRP between the second UE and the anchor UE is represented using n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the bit value corresponding to the information indicating whether an SL unicast communication is establishable between the second UE and the anchor UE is 0, indicating that SL unicast communication cannot be established between the second UE and the anchor UE. The bit value corresponding to the information indicating whether an SL unicast communication is establishable between the second UE and the anchor UE is 1, indicating that an SL unicast communication is establishable between the second UE and the anchor UE.

In some embodiments, the bit value corresponding to the information indicating whether an SL unicast communication is establishable between the second UE and the anchor UE is 0, indicating that an SL unicast communication is establishable between the second UE and the anchor UE. The bit value corresponding to the information indicating whether an SL unicast communication is establishable between the second UE and the anchor UE is 1, indicating that SL unicast communication cannot be established between the second UE and the anchor UE.

In some embodiments, the indication information is determined based on a comparison of magnitude between the RSRP information and RSRP threshold information.

In some embodiments, the request message further carries the RSRP threshold information.

In some embodiments, in a case where the RSRP between the second UE and the anchor UE is greater than the RSRP threshold, the requirement for establishing SL unicast communication is met, and an SL unicast communication is establishable between the second UE and the anchor UE. The indication information is used to indicate that an SL unicast communication is establishable between the second UE and the anchor UE.

In some embodiments, in a case where the RSRP between the second UE and the anchor UE is less than the RSRP threshold, the requirement for establishing SL unicast communication is not met, and SL unicast communication cannot be established between the second UE and the anchor UE. The indication information is used to indicate that SL unicast communication cannot be established between the second UE and the anchor UE.

In some embodiments, in the case where the RSRP between the second UE and the anchor UE is greater than the RSRP threshold, the bit value corresponding to the indication information is 1. In the case where the RSRP between the second UE and the anchor UE is less than the RSRP threshold, the bit value corresponding to the indication information is 0.

In some embodiments, in the case where the RSRP between the second UE and the anchor UE is greater than the RSRP threshold, the bit value corresponding to the indication information is 0. In the case where the RSRP between the second UE and the anchor UE is less than the RSRP threshold, the bit value corresponding to the indication information is 1.

In some embodiments, the number of SL unicast communications establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the number of SL unicast communications establishable between the second UE and the anchor UE is represented by a codepoint. The number of SL unicast communications establishable between the second UE and the anchor UE is in a one-to-one correspondence with the value of the codepoint.

In some embodiments, a binary value corresponding to three bits forms one codepoint, and each codepoint represents a quantity of SL unicast communications establishable between the second UE and the anchor UE. For example, 001 indicates that the number of SL unicast communications establishable between the second UE and the anchor UE is 1, and 010 indicates that the number of SL unicast communications establishable between the second UE and the anchor UE is 2.

In some embodiments, the corresponding relationship between the number of SL unicast communications establishable between the second UE and the anchor UE and the bit sequence and/or codepoint is determined through negotiation, stipulated by a protocol, or indicated by the target UE in the request message.

In some embodiments, the request message is further used to instruct the second UE to return at least one of the following pieces of information to the target UE:
RSRP information between the second UE and each anchor UE in a UE list;
information indicating whether an SL unicast communication is establishable between the second UE and each anchor UE in the UE list; or
the number of SL unicast communications establishable between the second UE and all anchor UEs in the UE list;
wherein the anchor UEs in the UE list are a subset of the anchor UEs.

In some embodiments, the UE list is a subset of a set formed by at least one anchor UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is determined based on a comparison of magnitude between the RSRP information and RSRP threshold information.

In some embodiments, the request message further carries the RSRP threshold information.

In some embodiments, in a case where the RSRP between the second UE and the anchor UE in the UE list is greater than the RSRP threshold, the requirement for establishing SL unicast communication is met, and an SL unicast communication is establishable between the second UE and the anchor UE in the UE list. The indication information is used to indicate that an SL unicast communication is establishable between the second UE and the anchor UE in the UE list.

In some embodiments, in a case where the RSRP between the second UE and the anchor UE in the UE list is less than the RSRP threshold, the requirement for establishing SL unicast communication is not met, and SL unicast communication cannot be established between the second UE and the anchor UE in the UE list. The indication information is used to indicate that SL unicast communication cannot be established between the second UE and the anchor UE in the UE list.

In some embodiments, in the case where the RSRP between the second UE and the anchor UE in the UE list is greater than the RSRP threshold, the bit value corresponding to the indication information is 1. In the case where the RSRP between the second UE and the anchor UE in the UE list is less than the RSRP threshold, the bit value corresponding to the indication information is 0.

In some embodiments, in the case where the RSRP between the second UE and the anchor UE in the UE list is greater than the RSRP threshold, the bit value corresponding to the indication information is 0. In the case where the RSRP between the second UE and the anchor UE in the UE list is less than the RSRP threshold, the bit value corresponding to the indication information is 1.

In some embodiments, the number of SL unicast communications establishable between the second UE and the anchor UE in the UE list is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE in the UE list. The i^{th} anchor UE is one anchor UE among the anchor UEs in the UE list.

In some embodiments, the number of SL unicast communications establishable between the second UE and the anchor UE in the UE list is represented by a codepoint. The number of SL unicast communications establishable between the second UE and the anchor UE in the UE list is in a one-to-one correspondence with the value of the codepoint.

In some embodiments, a binary value corresponding to three bits forms a codepoint, and each codepoint represents a quantity of SL unicast communications establishable between the second UE and the anchor UE in the UE list. For example, 001 indicates that the number of SL unicast communications establishable between the second UE and the anchor UE in the UE list is 1, and 010 indicates that the number of SL unicast communications establishable between the second UE and the anchor UE in the UE list is 2.

In some embodiments, the corresponding relationship between the number of SL unicast communications establishable between the second UE and the anchor UE in the UE list and the bit sequence and/or codepoint is determined by negotiation, stipulated by a protocol, or indicated by the target UE in the request message.

In some embodiments, the indication information is indicated using at least one of numbers, letters, symbols, or bits.

In some embodiments, the response message is further used to carry at least one of the following pieces of information of the second UE:
RSRP information between the second UE and the at least one anchor UE;
information indicating whether an SL unicast communication is establishable between the second UE and the at least one anchor UE; or
the number of SL unicast communications establishable between the second UE and the at least one anchor UE.

In some embodiments, the response message is further used to carry at least one of the following pieces of information of the second UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list;
wherein the anchor UEs in the UE list are a subset of the anchor UEs.

In some embodiments, the response message is used to indicate whether the receiver UE agrees to serve as the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the determining module 13 is configured to determine the SL positioning server UE based on the response messages.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the target UE calculates a mean RSRP of the second UE based on the RSRP information between the second UE and the anchor UE in the response information. The second UE with the largest mean RSRP is determined as the SL positioning server UE.

In some embodiments, the target UE determines the number of RSRPs greater than an RSRP threshold in the RSRP of the second UE based on the RSRP information between the second UE and the anchor UE in the response information. The second UE with the largest number of RSRPs greater than the RSRP threshold is determined as the SL positioning server UE.

In some embodiments, the target UE determines the number of anchor UEs capable of establishing an SL unicast communication with the second UE based on the information indicating whether an SL unicast communication is establishable between the second UE and the anchor UE in the response information. The second UE capable of establishing SL unicast communications with the largest number of anchor UEs is determined as the SL positioning server UE.

In some embodiments, the target UE determines the second UE capable of establishing SL unicast communications with the largest number of anchor UEs as the SL positioning server UE based on the number of SL unicast communications establishable between the second UE and the anchor UE in the response information.

In some embodiments, the transmitting module 14 is configured to transmit a confirmation message to the SL positioning server UE. The confirmation message is used to confirm that a receiver UE serves as the SL positioning server UE.

In some embodiments, the confirmation message is used to confirm that the receiver UE serves as the SL positioning server UE.

In some embodiments, the confirmation message is also referred to as at least one of an SL positioning server UE confirmation message, an SL positioning service confirmation message, an SL positioning UE confirmation message, an SL positioning confirmation message, a positioning server UE confirmation message, a positioning service confirmation message, or a positioning confirmation message.

In some embodiments, the confirmation message is also referred to as at least one of an SL positioning server UE role confirmation message, an SL positioning server role confirmation message, an SL positioning UE role confirmation message, an SL positioning role confirmation message, a positioning server UE role confirmation message, a positioning server role confirmation message, or a positioning role confirmation message.

In some embodiments, the transmitting module 14 is configured to transmit a notification message to at least one anchor UE. The notification message is used to indicate the SL positioning server UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message and/or request message to save signaling interaction.

In some embodiments, the notification message is carried in the metadata of the announcement message. For example, the role of the announcing UE is indicated as the target UE, and the server UE role is not indicated; the identification information of the server UE is carried in the metadata to save signaling interaction.

In some embodiments, the target UE may have different positioning service requests. To further distinguish the positioning session or ranging/SL positioning service request to which the SL positioning server UE belongs, the notification message further carries positioning session identification information.

In some embodiments, the notification message is carried in the SL positioning assistance information. The SL positioning assistance information is transmitted by broadcasting or multicasting. The target UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, the above-mentioned transmitting modules 14 for implementing different functions are implemented as the same transmitting module or are respectively implemented as different transmitting modules. The above-mentioned receiving modules 12 for implementing different functions are implemented as the same receiving module or are respectively implemented as different receiving modules. The above-mentioned determining modules 13 for implementing different functions are implemented as the same determining module or are respectively implemented as different determining modules. The embodiments do not impose any limitation in this regard.

FIG. 16 illustrates a structural block diagram of a communication apparatus applicable to an SL positioning service scenario according to some embodiments of the present disclosure. The apparatus may be implemented as all or part of an anchor UE in the SL positioning service scenario. The apparatus includes:
a receiving module 22, configured to receive a notification message.

The notification message is used to indicate an SL positioning server UE.

In some embodiments, the anchor UE receives a notification message from the target UE.

In some embodiments, the anchor UE receives a notification message from the SL positioning server UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message does not carry the identification information of the SL positioning server UE.

In some embodiments, the notification message is further used to indicate that the SL positioning server UE is a local UE.

In some embodiments, in a case where no identification information of the SL positioning server UE is present in the notification message, it is understood that the SL positioning server UE is indicated as the local UE.

In some embodiments, in a case where the identification information of the SL positioning server UE in the notification message is a special ID, it is understood that the SL positioning server UE is indicated as the local UE.

In some embodiments, the notification message carries bit indication information; and a bit value of the bit indication information being 1 or true indicates that the SL positioning server UE is indicated as the local UE.

In the above cases, the identification information of the SL positioning server UE may not be carried in the notification message, thereby saving signaling overhead.

In some embodiments, the notification message carries bit indication information; in a case where the bit value of the bit indication information is 0 or false, or in a case where the notification message does not carry the bit indication information, the notification message needs to carry complete identification information of the SL positioning server UE.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message. For example, the role of the announcing UE is indicated as the target UE, and the server UE role is not indicated; the identification information of the server UE is carried in the metadata to save signaling interaction.

In some embodiments, the target UE may have different positioning service requests. To further distinguish the positioning session or ranging/SL positioning service request to which the SL positioning server UE belongs, the notification message further carries positioning session identification information.

In some embodiments, the role of an announcing UE includes a target UE, an SL positioning server UE, an anchor UE, and an anchor UE capable of acquiring its own position. The role of the announcing UE being the SL positioning server UE means that the announcing UE can implement the function of an SL positioning server UE. However, it has not been determined who is the SL positioning server UE for a certain SL positioning service request.

In some embodiments, the notification message is carried in the SL positioning assistance information. The SL positioning assistance information is transmitted by broadcasting or multicasting. The target UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, the notification message is carried in the metadata of the announcement message, and by introducing a new UE role, such as “authorized server UE” or “confirmed server UE”, the UE is implicitly indicated as the SL positioning server UE, so as to save signaling interaction.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the SL positioning server UE is one of the following UEs:
a target UE;
an anchor UE; or
another UE other than the target UE and the anchor UE.

In some embodiments, the above-mentioned receiving modules 22 for implementing different functions are implemented as the same receiving module or are respectively implemented as different receiving modules. The embodiments do not impose any limitation in this regard.

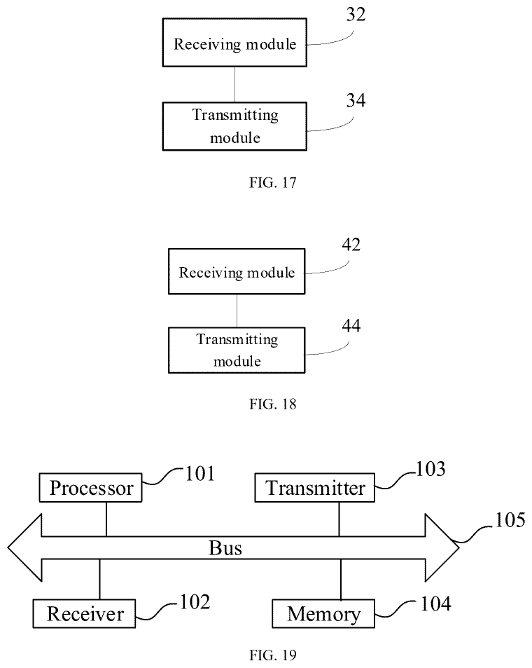

FIG. 17 illustrates a structural block diagram of a communication apparatus applicable to an SL positioning service scenario according to some embodiments of the present disclosure. The apparatus is configured to implement the second UE in the SL positioning service scenario. The apparatus includes:
a receiving module 32, configured to receive a request message from a target UE; and
a transmitting module 34, configured to transmit a response message to the target UE, the response message carrying information for the target UE to determine an SL positioning server UE.

The second UE is one of candidate UEs, wherein the candidate UEs are UEs that are candidates of the SL positioning server UE. The request message is used to request the second UE to serve as the SL positioning server UE.

In some embodiments, the response message carries at least one of the following pieces of information:
RSRP information between the second UE and at least one anchor UE;
information indicating whether an SL unicast communication is establishable between the second UE and the at least one anchor UE; or
the number of UEs capable of establishing an SL unicast communication between the second UE and the at least one anchor UE.

In some embodiments, the response message carries at least one of the following pieces of information:
RSRP information between the second UE and each anchor UE in a UE list;
information indicating whether an SL unicast communication is establishable between the second UE and each anchor UE in the UE list; or
the number of UEs capable of establishing SL unicast communications between the second UE and all anchor UEs in the UE list.

The anchor UEs in the UE list are a subset of the anchor UEs.

In some embodiments, the UE list is a subset of a set formed by at least one anchor UE.

In some embodiments, the second UE is a UE that is a candidate to become an SL positioning server UE.

In some embodiments, the second UE is at least one of an anchor UE or another UE except the anchor UE and the target UE.

In some embodiments, the second UE is a UE that supports the SL positioning server UE function.

In some embodiments, the second UE is also referred to as at least one of an SL positioning service second UE, an SL positioning second UE, an SL service second UE, a positioning second UE, or a positioning service second UE.

In some embodiments, the request message is used to request the second UE to serve as an SL positioning server UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, the request message is further used to instruct the second UE to return at least one of the following pieces of information to the target UE:
RSRP information between the second UE and the at least one anchor UE;
information indicating whether an SL unicast communication is establishable between the second UE and the at least one anchor UE; or
the number of UEs capable of establishing an SL unicast communication between the second UE and the at least one anchor UE.

In some embodiments, the request message is further used to instruct the second UE to return at least one of the following pieces of information to the target UE:

RSRP information between the second UE and each anchor UE in a UE list;
information indicating whether an SL unicast communication is establishable between the second UE and each anchor UE in the UE list; or
the number of UEs capable of establishing SL unicast communications between the second UE and all anchor UEs in the UE list;
wherein the anchor UEs in the UE list are a subset of the anchor UEs.

In some embodiments, the UE list is a subset of a set formed by at least one anchor UE.

In some embodiments, the response message further includes a capability response message.

In some embodiments, the request message further includes a capability request message.

In some embodiments, the request message further includes a capability request message.

In some embodiments, during the capability exchange process, the second UE receives the capability request message from the target UE.

In some embodiments, the capability exchange process is also referred to as at least one of an exchange process, a capability interaction process, an SL positioning capability exchange process, or an SL positioning capability interaction process.

In some embodiments, the capability request message is also referred to as at least one of a request message, an exchange request message, an interaction request message, a capability exchange request message, a capability interaction request message, an SL positioning capability request message, an SL positioning capability exchange request message, or an SL positioning capability interaction request message.

In some embodiments, the capability request message is further used to instruct the second UE to return at least one of the following pieces of information to the target UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the capability request message is further used to instruct the second UE to return at least one of the following pieces of information to the target UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The second UE is one of candidate UEs, wherein the candidate UEs are UEs that are candidates of the SL positioning server UE. The UE list is a subset of a set formed by at least one anchor UE.

In some embodiments, each RSRP between the second UE and the anchor UE is represented using n bits.

In some embodiments, the n bits corresponding to the RSRP are used to represent an absolute value of the RSRP. The absolute value of the RSRP is in a one-to-one correspondence with the number of bits.

In some embodiments, the information indicating whether an SL unicast communication is establishable between the second UE and the anchor UE is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE. The i^{th} anchor UE is one anchor UE among the anchor UEs.

In some embodiments, the bit value corresponding to the information indicating whether an SL unicast communication is establishable between the second UE and the anchor UE is 0, indicating that SL unicast communication cannot be established between the second UE and the anchor UE. The bit value corresponding to the information indicating whether an SL unicast communication is establishable between the second UE and the anchor UE is 1, indicating that an SL unicast communication is establishable between the second UE and the anchor UE.

In some embodiments, the bit value corresponding to the information indicating whether an SL unicast communication is establishable between the second UE and the anchor UE is 0, indicating that an SL unicast communication is establishable between the second UE and the anchor UE. The bit value corresponding to the information indicating whether an SL unicast communication is establishable between the second UE and the anchor UE is 1, indicating that SL unicast communication cannot be established between the second UE and the anchor UE.

In some embodiments, the RSRP information is acquired based on measurement of an announcement message during an SL discovery process.

In some embodiments, the RSRP information is acquired based on measurement of a request message during an SL discovery process.

In some embodiments, the indication information is determined based on a comparison of magnitude between the RSRP information and RSRP threshold information.

In some embodiments, the request message further carries the RSRP threshold information.

In some embodiments, the capability request message further carries the RSRP threshold information.

In some embodiments, in a case where the RSRP between the second UE and the anchor UE in the UE list is greater than the RSRP threshold, the requirement for establishing SL unicast communication is met, and an SL unicast communication is establishable between the second UE and the anchor UE in the UE list. The indication information is used to indicate that an SL unicast communication is establishable between the second UE and the anchor UE in the UE list.

In some embodiments, in a case where the RSRP between the second UE and the anchor UE in the UE list is less than the RSRP threshold, the requirement for establishing SL unicast communication is not met, and SL unicast communication cannot be established between the second UE and the anchor UE in the UE list. The indication information is used to indicate that SL unicast communication cannot be established between the second UE and the anchor UE in the UE list.

In some embodiments, in the case where the RSRP between the second UE and the anchor UE in the UE list is greater than the RSRP threshold, the bit value corresponding to the indication information is 1. In the case where the RSRP between the second UE and the anchor UE in the UE list is less than the RSRP threshold, the bit value corresponding to the indication information is 0.

In some embodiments, in the case where the RSRP between the second UE and the anchor UE in the UE list is greater than the RSRP threshold, the bit value corresponding to the indication information is 0. In the case where the RSRP between the second UE and the anchor UE in the UE list is less than the RSRP threshold, the bit value corresponding to the indication information is 1.

In some embodiments, the number of SL unicast communications establishable between the second UE and the anchor UE in the UE list is represented by a bit sequence. Each bit in the bit sequence is used to indicate whether an SL unicast communication is establishable between the second UE and each anchor UE.

In some embodiments, the i^{th} bit in the bit sequence indicates that an SL unicast communication is establishable between the second UE and the i^{th} anchor UE in the UE list. The i^{th} anchor UE is one anchor UE among the anchor UEs in the UE list.

In some embodiments, the number of SL unicast communications establishable between the second UE and the anchor UE in the UE list is represented by a codepoint. The number of SL unicast communications establishable between the second UE and the anchor UE in the UE list is in a one-to-one correspondence with the value of the codepoint.

In some embodiments, a binary value corresponding to three bits forms a codepoint, and each codepoint represents a quantity of SL unicast communications establishable between the second UE and the anchor UE in the UE list. For example, 001 indicates that the number of SL unicast communications establishable between the second UE and the anchor UE in the UE list is 1, and 010 indicates that the number of SL unicast communications establishable between the second UE and the anchor UE in the UE list is 2.

In some embodiments, the corresponding relationship between the number of SL unicast communications establishable between the second UE and the anchor UE in the UE list and the bit sequence and/or codepoint is determined by negotiation, stipulated by a protocol, or indicated by the target UE in the request message.

In some embodiments, the indication information is indicated using at least one of numbers, letters, symbols, or bits.

In some embodiments, the response message carries information for the target UE to determine the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message further includes a capability response message.

In some embodiments, during the capability exchange process, the second UE returns a capability response message to the target UE.

In some embodiments, the capability exchange process is also referred to as at least one of an exchange process, a capability interaction process, an SL positioning capability exchange process, or an SL positioning capability interaction process.

In some embodiments, the capability response message is also referred to as at least one of a response message, an exchange response message, an interaction response message, a capability exchange response message, or a capability interaction response message.

In some embodiments, the capability response message is further used to carry at least one of the following pieces of information of the second UE:
RSRP information between the second UE and at least one anchor UE;
information indicating whether an SL unicast communication is establishable between the second UE and at least one anchor UE; or
the number of SL unicast communications establishable between the second UE and at least one anchor UE.

In some embodiments, the capability response message is further used to carry at least one of the following pieces of information of the second UE:
RSRP information between the second UE and each anchor UE in the UE list;
information indicating whether an SL unicast communication is establishable between the second UE and each anchor UE in the UE list; or
the number of SL unicast communications establishable between the second UE and all anchor UEs in the UE list.

The anchor UEs in the UE list are a subset of the anchor UEs.

In some embodiments, the UE list is a subset of a set formed by at least one anchor UE.

In some embodiments, the above-mentioned transmitting modules 34 for implementing different functions are implemented as the same transmitting module or are respectively implemented as different transmitting modules. The above-mentioned receiving modules 32 for implementing different functions are implemented as the same receiving module or are respectively implemented as different receiving modules. The embodiments do not impose any limitation in this regard.

FIG. 18 illustrates a structural block diagram of a communication apparatus applicable to an SL positioning service scenario according to some embodiments of the present disclosure. The apparatus may be implemented as all or part of an SL positioning server UE in the SL positioning service scenario. The apparatus includes:
a receiving module 42, configured to receive a request message from a target UE; and
a transmitting module 44, configured to transmit a response message to the target UE.

The request message is used to request a receiver UE to serve as the SL positioning server UE, and the response message is used to indicate whether the receiver UE agrees to serve as the SL positioning server UE.

In some embodiments, the request message is used to request a receiver UE to serve as the SL positioning server UE.

In some embodiments, the receiver UE is also referred to as at least one of an SL positioning service receiver UE, an SL positioning receiver UE, an SL service receiver UE, a positioning receiver UE, or a positioning service receiver UE.

In some embodiments, the request message is also referred to as at least one of an SL positioning server UE request message, an SL positioning service request message, an SL positioning UE request message, an SL positioning request message, a positioning server UE request message, a positioning service request message, or a positioning request message.

In some embodiments, the response message is used to indicate whether the receiver UE agrees to serve as the SL positioning server UE.

In some embodiments, the response message is also referred to as at least one of an SL positioning server UE response message, an SL positioning service response message, an SL positioning UE response message, an SL positioning response message, a positioning server UE response message, a positioning service response message, or a positioning response message.

In some embodiments, the response message includes a first bit, wherein a bit value of the first bit is used to indicate whether the receiver UE agrees to serve as the SL positioning server UE. The first bit is one of the bits corresponding to the response message.

In some embodiments, the bit value corresponding to the first bit being 0 indicates that the receiver UE does not agree to serve as the SL positioning server UE. The bit value corresponding to the first bit being 1 indicates that the receiver UE agrees to serve as the SL positioning server UE.

In some embodiments, the bit value corresponding to the first bit being 1 indicates that the receiver UE does not agree to serve as the SL positioning server UE. The bit value corresponding to the first bit being 0 indicates that the receiver UE agrees to serve as the SL positioning server UE.

In some embodiments, in a case where the response message indicates that the receiver UE does not agree to serve as the SL positioning server UE, the target UE re-determines the SL positioning server UE.

In some embodiments, in a case where the target UE does not receive a response message, the target UE re-determines the SL positioning server UE.

In some embodiments, the receiving module 42 is configured to receive a confirmation message from the target UE. The confirmation message is used to confirm that a receiver UE serves as the SL positioning server UE.

In some embodiments, the confirmation message is used to confirm that the receiver UE serves as the SL positioning server UE.

In some embodiments, the confirmation message is also referred to as at least one of an SL positioning server UE confirmation message, an SL positioning service confirmation message, an SL positioning UE confirmation message, an SL positioning confirmation message, a positioning server UE confirmation message, a positioning service confirmation message, or a positioning confirmation message.

In some embodiments, the confirmation message is also referred to as at least one of an SL positioning server UE role confirmation message, an SL positioning server role confirmation message, an SL positioning UE role confirmation message, an SL positioning role confirmation message, a positioning server UE role confirmation message, a positioning server role confirmation message, or a positioning role confirmation message.

In some embodiments, the transmitting module 44 is configured to transmit a notification message to at least one anchor UE. The notification message is used to indicate the SL positioning server UE.

In some embodiments, the SL positioning server UE is a UE that implements the SL positioning server UE function.

In some embodiments, the SL positioning server UE is also referred to as at least one of an SL positioning UE, an SL server UE, a positioning UE, or a positioning server UE.

In some embodiments, the SL positioning server UE is also referred to as at least one of an SL positioning server role UE, an SL positioning role UE, an SL server role UE, a positioning role UE, a positioning server role UE, or a role UE.

In some embodiments, the SL positioning server UE is one of the following UEs:
a target UE;
an anchor UE; or
another UE other than the target UE and the anchor UE.

In some embodiments, the notification message is used to indicate the SL positioning server UE implementing the SL positioning server UE function.

In some embodiments, the notification message is also referred to as at least one of an SL positioning server UE notification message, an SL positioning service notification message, an SL positioning UE notification message, an SL positioning notification message, a positioning server UE notification message, a positioning service notification message, or a positioning notification message.

In some embodiments, the notification message is also referred to as at least one of an SL positioning server UE role notification message, an SL positioning server role notification message, an SL positioning UE role notification message, an SL positioning role notification message, a positioning server UE role notification message, a positioning service role notification message, or a positioning role notification message.

In some embodiments, the notification message carries identification information of the SL positioning server UE.

In some embodiments, the notification message further carries identification information of the target UE.

In some embodiments, the notification message further carries positioning session identification (SLPP session ID) information, wherein the positioning session identification information is used to indicate that for a specific positioning session and/or a specific ranging/SL positioning service request, the SL positioning server UE implements the SL positioning server UE function. The positioning session identification information is used to distinguish between different positioning sessions or ranging/SL positioning service requests.

In some embodiments, the identification information includes user information.

In some embodiments, the user information is a user ID.

In some embodiments, the user information is a layer-2 ID.

In some embodiments, the user information is an application layer ID.

In some embodiments, the notification message is transmitted by at least one of broadcasting, unicasting, or multicasting.

In some embodiments, the notification message does not carry the identification information of the SL positioning server UE.

In some embodiments, the notification message is further used to indicate that the SL positioning server UE is a local UE.

In some embodiments, in a case where no identification information of the SL positioning server UE is present in the notification message, it is understood that the SL positioning server UE is indicated as the local UE.

In some embodiments, in a case where the identification information of the SL positioning server UE in the notification message is a special ID, it is understood that the SL positioning server UE is indicated as the local UE.

In some embodiments, the notification message carries bit indication information; and the bit value of the bit indication information being 1 or true indicates that the SL positioning server UE is indicated as the local UE.

In the above cases, the identification information of the SL positioning server UE may not be carried in the notification message, thereby saving signaling overhead.

In some embodiments, the notification message carries bit indication information; in a case where the bit value of the bit indication information is 0 or false, or in a case where the notification message does not carry the bit indication information, the notification message needs to carry complete identification information of the SL positioning server UE.

In some embodiments, the notification message is carried in at least one of the following pieces of information:
SL positioning assistance information (SLPP positioning assistance data);
announcement message for the SL discovery process;
a request message for the SL discovery process; or
NAS signaling.

In some embodiments, the notification message is carried in the metadata of the announcement message and/or request message to save signaling interaction.

In some embodiments, the role of an announcing UE includes a target UE, an SL positioning server UE, an anchor UE, and an anchor UE capable of acquiring its own position. The role of the announcing UE being the SL positioning server UE means that the announcing UE can implement the function of an SL positioning server UE. However, it has not been determined who is the SL positioning server UE for a certain SL positioning service request.

In some embodiments, the notification message is carried in the metadata of the announcement message, and by introducing a new UE role, such as “authorized server UE” or “confirmed server UE”, the UE is implicitly indicated as the SL positioning server UE, so as to save signaling interaction.

In some embodiments, the notification message is carried in the SL positioning assistance information. The SL positioning assistance information is transmitted by broadcasting or multicasting. The SL positioning server UE carries a notification message in the SL positioning assistance information. Even though the target UE may have different positioning service requests, since the SL positioning assistance information itself is within a certain positioning session, an additional indication for positioning session identification information is not needed, which can avoid introducing new signaling and is used to save signaling interaction.

In some embodiments, the above-mentioned transmitting modules 44 for implementing different functions are implemented as the same transmitting module or are respectively implemented as different transmitting modules. The above-mentioned receiving modules 42 for implementing different functions are implemented as the same receiving module or are respectively implemented as different receiving modules. The embodiments do not impose any limitation in this regard.

FIG. 19 illustrates a schematic structural diagram of a communication device (a terminal, a network device, or an SL positioning device) according to some embodiments of the present disclosure. The communication device includes a processor 101, a receiver 102, a transmitter 103, a memory 104, and a bus 105.

The processor 101 includes one or more processing cores, and the processor 101 executes various functional applications and performs information processing by running software programs and modules.

The receiver 102 and the transmitter 103 are implemented as a communication assembly, wherein the communication assembly may be a communication chip and may be referred to as a transceiver.

The memory 104 is connected to the processor 101 by the bus 105.

The memory 104 is configured to store at least one instruction, and the processor 101 is configured to execute the at least one instruction to perform the processes in the above method embodiments.

In addition, the memory 104 may be implemented by any type or combination of volatile or non-volatile storage devices including, but not limited to: a magnetic or optical disk, an electrically-erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In a case where the communication device is implemented as a terminal, the processor and transceiver in the communication device according to the embodiments of the present disclosure can execute the processes performed by the terminal in any one of the methods described above, which will not be elaborated herein any further.

In some embodiments, in the case where the communication device is implemented as a terminal, the terminal includes:
a processor;
a transceiver, connected to the processor; and
a memory, configured to store one or more executable instructions of the processor.

The processor is configured to load the one or more executable instructions to cause the terminal to perform the method for transmitting a notification message in the above method embodiments.

The present disclosure further provides a computer-readable storage medium, which stores one or more executable instructions. The one or more executable instructions, when loaded and executed by a processor, cause the processor to perform the method for transmitting a notification message in the above method embodiments.

The present disclosure further provides a chip, which includes one or more programmable logic circuits or one or more programs. The chip, when running the one or more programmable logic circuits or the one or more programs, is caused to perform the method for transmitting a notification message in the above method embodiments.

The present disclosure further provides a computer program product, which includes one or more computer instructions stored in a computer-readable storage medium. The one or more computer instructions, when read by a processor of a communication device from the computer-readable storage medium and executed by the processor, cause the communication device to perform the method for transmitting a notification message in the above method embodiments.

Those skilled in the art should recognize that in the one or more examples described above, the functions described in the embodiments of the present disclosure may be implemented using hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely optional embodiments of the present disclosure and are not intended to limit the present disclosure. Any modifications, equivalent substitutions, improvements, and the like, made within the spirit and principle of the present disclosure shall fall within the protection scope of the present disclosure.

1. A terminal applicable to a sidelink (SL) positioning service scenario, wherein the terminal is applied in a target user equipment (UE), and the terminal comprises:
a processor;
a transceiver, connected to the processor; and
a memory, configured to store one or more executable instructions of the processor;
wherein the processor is configured to load the one or more executable instructions to cause the terminal to:
receive a ranging/SL positioning service request; and
determine an SL positioning server UE,
wherein the SL positioning server UE is a UE used to implement an SL positioning service function.

2. The terminal according to claim 1, wherein the target UE determines the SL positioning server UE based on at least one of:
reference signal received power (RSRP) information between a first UE and at least one anchor UE;
information indicating whether an SL unicast communication is establishable between a first UE and at least one anchor UE;
a number of SL unicast communications establishable between a first UE and at least one anchor UE;
RSRP information between a first UE and each anchor UE in a UE list;
information indicating whether an SL unicast communication is establishable between a first UE and each anchor UE in a UE list; or
a number of SL unicast communications establishable between a first UE and all anchor UEs in a UE list;
wherein the first UE is one of a plurality of UEs, the plurality of UEs being UEs performing capability exchange with the target UE; and the UE list is a subset of a set formed by at least one anchor UE.

3. The terminal according to claim 1, wherein the target UE determines the SL positioning server UE based on at least one of:
reference signal received power (RSRP) information between a second UE and at least one anchor UE;
information indicating whether an SL unicast communication is establishable between a second UE and at least one anchor UE;
a number of SL unicast communications establishable between a second UE and at least one anchor UE;
RSRP information between a second UE and each anchor UE in a UE list;
information indicating whether an SL unicast communication is establishable between a second UE and each anchor UE in a UE list; or
a number of SL unicast communications establishable between a second UE and all anchor UEs in a UE list;
wherein the second UE is one of candidate UEs, the candidate UEs being UEs that are candidates of the SL positioning server UE; and the UE list is a subset of a set formed by at least one anchor UE.

4. The terminal according to claim 1, wherein the processor is configured to load the one or more executable instructions to further cause the terminal to:
transmit a request message to the SL positioning server UE; and
receive a response message from the SL positioning server UE;
wherein the request message is used to request a receiver UE to serve as the SL positioning server UE, and the response message is used to indicate whether the receiver UE agrees to serve as the SL positioning server UE.

5. The terminal according to claim 1, wherein the processor is configured to load the one or more executable instructions to further cause the terminal to:
transmit capability request messages to a plurality of UEs; and
receive capability response messages from the plurality of UEs; and
the processor is configured to load the one or more executable instructions to cause the terminal to:
determine the SL positioning server UE based on the capability response messages.

6. The terminal according to claim 5, wherein the capability request message is further used to instruct a first UE in the plurality of UEs to return at least one of the following pieces of information to the target UE:
reference signal received power (RSRP) information between the first UE and at least one anchor UE;
information indicating whether an SL unicast communication is establishable between the first UE and at least one anchor UE;
a number of SL unicast communications establishable between the first UE and at least one anchor UE;
RSRP information between the first UE and each anchor UE in a UE list;
information indicating whether an SL unicast communication is establishable between the first UE and each anchor UE in a UE list; or
a number of SL unicast communications establishable between the first UE and all anchor UEs in a UE list;
wherein the first UE is one of a plurality of UEs, the plurality of UEs being UEs performing capability exchange with the target UE; and the UE list is a subset of a set formed by at least one anchor UE.

7. The terminal according to claim 6, wherein in a case where the capability request message is further used to instruct the first UE in the plurality of UEs to return at least one of the following pieces of information to the target UE: the RSRP information between the first UE and at least one anchor UE, the information indicating whether the SL unicast communication is establishable between the first UE and at least one anchor UE, or the number of SL unicast communications establishable between the first UE and at least one anchor UE,
the capability response message is further used to carry at least one of the following pieces of information of the first UE in the plurality of UEs:
the RSRP information between the first UE and the at least one anchor UE;
the information indicating whether an SL unicast communication is establishable between the first UE and the at least one anchor UE; or
the number of SL unicast communications establishable between the first UE and the at least one anchor UE.

8. The terminal according to claim 6, wherein in a case where the capability request message is further used to instruct the first UE in the plurality of UEs to return at least one of the following pieces of information to the target UE: the RSRP information between the first UE and each anchor UE in the UE list, the information indicating whether the SL unicast communication is establishable between the first UE and each anchor UE in the UE list, or the number of SL unicast communications establishable between the first UE and all anchor UEs in the UE list,
the capability response message is further used to carry at least one of the following pieces of information of a first UE in the plurality of UEs:
RSRP information between the first UE and each anchor UE in the UE list;
information indicating whether an SL unicast communication is establishable between the first UE and each anchor UE in the UE list; or
a number of SL unicast communications establishable between the first UE and all anchor UEs in the UE list.

9. The terminal according to claim 3, wherein the processor is configured to load the one or more executable instructions to further cause the terminal to:
transmit request messages to a plurality of second UEs; and
receive response messages from the plurality of second UEs;
wherein the request messages are used to request the second UEs to serve as the SL positioning server UE, and the response messages are used to indicate whether the second UEs agree to serve as the SL positioning server UE.

10. The terminal according to claim 9, wherein the request message is further used to instruct the second UE to return at least one of the following pieces of information to the target UE:
RSRP information between the second UE and at least one anchor UE;
information indicating whether an SL unicast communication is establishable between the second UE and at least one anchor UE;
a number of SL unicast communications establishable between the second UE and at least one anchor UE;
RSRP information between the second UE and each anchor UE in a UE list;
information indicating whether an SL unicast communication is establishable between the second UE and each anchor UE in a UE list; or
a number of SL unicast communications establishable between the second UE and all anchor UEs in a UE list;
wherein the second UE is one of candidate UEs, the candidate UEs being UEs that are candidates of the SL positioning server UE; and the UE list is a subset of a set formed by at least one anchor UE.

11. The terminal according to claim 9, wherein the processor is configured to load the one or more executable instructions to cause the terminal to:
determine the SL positioning server UE based on the response message; and
the processor is configured to load the one or more executable instructions to further cause the terminal to:
transmit a confirmation message to the SL positioning server UE,
wherein the confirmation message is used to confirm that a receiver UE serves as the SL positioning server UE.

12. The terminal according to claim 2, wherein the RSRP information is acquired based on measurement of an announcement message during an SL discovery process; or
the RSRP information is acquired based on measurement of a request message during an SL discovery process; or
the indication information is determined based on a comparison of magnitude between the RSRP information and RSRP threshold information.

13. The terminal according to claim 1, wherein the processor is configured to load the one or more executable instructions to further cause the terminal to:
transmit a notification message to at least one anchor UE,
wherein the notification message is used to indicate the SL positioning server UE; and the notification message carries at least one of:
SL positioning assistance information;
an announcement message for an SL discovery process;
a request message for an SL discovery process; or
non-access stratum (NAS) signaling.

14. The terminal according to claim 13, wherein the notification message carries identification information of the SL positioning server UE and identification information of the target UE.

15. The terminal according to claim 13, wherein the SL positioning server UE is one of:
the target UE;
the anchor UE; or
another UE other than the target UE and the anchor UE.

16. A terminal applicable to a sidelink (SL) positioning service scenario, wherein the terminal is applied to a second user equipment (UE), and the terminal comprises:
a processor;
a transceiver, connected to the processor; and
a memory, configured to store one or more executable instructions of the processor;
wherein the processor is configured to load the one or more executable instructions to cause the terminal to:
receive a request message from a target UE; and
transmit a response message to the target UE, the response message carrying information for the target UE to determine an SL positioning server UE;
wherein the second UE is one of candidate UEs, the candidate UEs being UEs that are candidates of the SL positioning server UE; and the request message is used to request the second UE to serve as the SL positioning server UE.

17. The terminal according to claim 16, wherein the response message carries at least one of:
reference signal received power (RSRP) information between the second UE and at least one anchor UE;
information indicating whether an SL unicast communication is established between the second UE and the at least one anchor UE; or
a number of UEs capable of establishing an SL unicast communication between the second UE and the at least one anchor UE.

18. The terminal according to claim 16, wherein the response message carries at least one of:
reference signal received power (RSRP) information between the second UE and each anchor UE in a UE list;
information indicating whether an SL unicast communication is established between the second UE and each anchor UE in a UE list; or
a number of UEs capable of establishing SL unicast communications between the second UE and all anchor UEs in a UE list;
wherein the UE list is a subset of a set formed by at least one anchor UE.

19. A terminal applicable to a sidelink (SL) positioning service scenario, wherein the terminal is applied to an SL positioning server user equipment (UE), and the terminal comprises:
a processor;
a transceiver, connected to the processor; and
a memory, configured to store one or more executable instructions of the processor;
wherein the processor is configured to execute the one or more executable instructions to cause the terminal to:
receive a request message from a target UE; and
transmit a response message to the target UE;
wherein the request message is used to request a receiver UE to serve as the SL positioning server UE, and the response message is used to indicate whether the receiver UE agrees to serve as the SL positioning server UE.

20. The terminal according to claim 19, wherein the processor is configured to execute the one or more executable instructions to further cause the terminal to:
receive a confirmation message from the target UE;
wherein the confirmation message is used to confirm that a receiver UE serves as the SL positioning server UE.
